(19) United States
(12) Patent Application Publication
(10) Pub. No.: US 2021/0082070 A1
(43) Pub. Date: Mar. 18, 2021

(54) DATABASE AND MACHINE LEARNING ENABLED SYSTEM FOR PATENT ANALYTICS, DISTRIBUTION AND MANAGEMENT

(71) Applicant: IPwe, Inc., Dover, DE (US)

(72) Inventors: NICOLE ANN SHANAHAN, PALO ALTO, CA (US); YURI V. YERASTOV, PALO ALTO, CA (US)

(21) Appl. No.: 16/939,857

(22) Filed: Jul. 27, 2020

Related U.S. Application Data
(60) Provisional application No. 62/880,031, filed on Jul. 29, 2019.

(51) Int. Cl. G06Q 50/18; G06F 16/332; G06F 16/383; H04L 29/06; G06K 9/62; G06N 20/00

(52) U.S. Cl. CPC G06Q 50/184; G06F 16/3329; G06F 16/383; G06N 20/00; H04L 63/101; G06K 9/6256; H04L 63/0414

(57) ABSTRACT

The present invention provides a machine learning model is trained on a plurality of patents. The present invention couples the machine learning model to a platform where a partner can discover inventions identified by the machine learning model and contact the patent owner in the real world to engage in discussions about acquiring the patent or the technology. The goal of the present invention is to enhance broader access to patent and technology rights across the innovation ecosystem.

### PRIORITY CLAIMS

This application claims the benefit of U.S. Provisional Patent Application Ser. No. 62/880,031 filed on Jul. 29, 2019, which is incorporated herein by reference.

### BACKGROUND OF THE INVENTION

The present invention relates to a machine-learning enabled platform for analyzing, managing, and distributing patent rights.

### SUMMARY OF THE INVENTION

The present invention provides a machine learning model is trained on a plurality of patents. The present invention couples the machine learning model to a platform where a partner can discover inventions identified by the machine learning model and contact the patent owner in the real world to engage in discussions about acquiring the patent or the technology. The goal of the present invention is to enhance broader access to patent and technology rights across the innovation ecosystem.

### BRIEF DESCRIPTION OF THE DRAWINGS

Embodiments of the present invention will be better understood from a reading of the following detailed description, taken in conjunction with the accompanying drawing figures in which like reference characters designate like elements and in which:

FIG. 1 [100] illustrates a diagram a flow diagram of the overall system working cohesively to manage, analyze, and transact intellectual property assets;

FIG. 1 [101] represents the portfolio management segment of the system that includes docketing, document management, chronological due dates, records management, and invention disclosures (which includes a functionality to run the machine learning engine);

FIG. 1 [102] represents the virtual deal room segment of the system that includes a virtual data room (which includes a functionality to run the machine learning engine), an aggregated view of IP assets, share functionality, document and contract attachments and the like;

FIG. 1 [103] represents the user interface ability to toggle between portfolio management [101] and the virtual deal room segment [102];

FIG. 1 [104] represents the computational logic that is run continuously on all imported intellectual property assets that applies new data and updates and they are detected via a plurality of APIs;

FIG. 2 [200] is a flow diagram of the complete system representing how the back end and front-end interact to provide an end-to-end platform for intellectual property asset management, analysis, and transaction;

FIG. 2 [201] represents the portfolio management front-end user interface where users are able to perform a number of user actions, and experience a number of user views;

FIG. 2 [202] is the transmission of user provided intellectual asset serial numbers to user databases;

FIG. 2 [203] represents the user databases where user data is stored and represented via the front-end [101];

FIG. 2 [204] represents the API that registers user serial numbers against a database containing all government intellectual asset data;

FIG. 2 [205] represents bulk databases of a plurality of government intellectual asset data sets;

FIG. 2 [206] represents the API that sends packets of data for registered user back to the user databases [203];

FIG. 2 [207] is the computational logic rules engine that processes registered user data against a set of rules that determine the status of relevant actions related to the registered user data;

FIG. 2 [208] is the process of submitted the registered user data and the related rules to the user databases;

FIG. 2 [209] represented the process of displaying the completed user records to the user via the front-end [201];

FIG. 2 [210] is the Invention Disclosure front-end containing an interface for a number of user actions and user views;

FIG. 2 [211] is the process by which the user database stores and provides data for the user interface;

FIG. 2 [212] is the virtual IP deal room front-end containing an interface for a number of user actions and user views;

FIG. 2 [213] is the process by which the user database stores and provides data for the virtual IP deal room user interface;

FIG. 2 [214] is the machine learning analytics engine containing a plurality of databases, crawl bots, and functions;

FIG. 2 [215] is the API JSON file that sends invention disclosure contents to the machine learning analytics engine;

FIG. 2 [216] is the analytics databases storing a plurality of collected data sets related to the intellectual assets analytics engine [214];

FIG. 2 [217] a second set of bulk databases containing government intellectual property data;

FIG. 2 [217] a machine learning model that is trained on the bulk databases [217];

FIG. 2 [219] the program designed to continuously train the machine learning model on new entering the bulk databases [217];

FIG. 2 [220] the machine learning model provides answers and search results based on inputs requested by the user via the user front-ends [210] and [212], and the results are stored in the analytics database [216];

FIG. 2 [221] is an articles crawl bot that crawls and extracts written content from a wide plurality of online sources;

FIG. 2 [222] is the process by which the articles crawl bot [221] provides content related to user inputs from [210] and [212] to the analytics databases;

[FIG. 2 [223] is an inventor crawl bot that crawls inventor information from a plurality of online sources;

FIG. 2 [224] is the process by which the inventor crawl bot [223] provides content related to user inputs from [210] and [212] to the analytics databases;

FIG. 2 [225] is a product crawl both that crawls product information from a plurality of online sources;

FIG. 2 [226] is the process by which the product crawl bot [225] provides content related to user inputs from [210] and [212] to the analytics databases;

FIG. 2 [227] is an organization crawl both that crawls organization information from a plurality of online sources;

FIG. 2 [228] is the process by which the organization crawl bot [227] provides content related to user inputs from [210] and [212] to the analytics databases;

FIG. 2 [229] is a sentiment model and crawl bot that crawls opinion information from a plurality of online sources;

FIG. 2 [230] is the process by which the sentiment model and crawl bot [229] provides sentiment analysis related to user inputs from [210] and [212];

FIG. 2 [231] is the API JSON content that is provided by the user via the virtual IP Deal Room Front-End [212], to the Machine Learning Analytics Engine [214] for processing;

FIG. 2 [232] is the API JSON content that is provided to front-end [212] after the machine learning analytics engine [214] has completed processing;

FIG. 2 [233] is the user front-end analytics dashboard where user can dynamically explore a plurality of data provided by the machine learning engine [214];

FIG. 2 [234] is the API JSON content that is provided to the analytics dashboard front-end [233] after processing by the machine learning analytics engine [214];

FIG. 3A-3B is the user interface for the administrator dashboard;

FIG. 4A-4B is the user interface for a newly created profile, allowing the user to import new intellectual asset serial numbers;

FIG. 5A-5F is the user interface of a populated profile account, and the All Applications tab;

FIG. 6A-6D is the user interface of the New Actions tab of the Pending Applications section of the application;

FIG. 7A-7D is the user interface of the Pending Actions tab of the of the Pending Applications section of the application;

FIG. 8A-8C is the user interface for selecting and automating any extensions related to a New or Pending Action;

FIG. 9A-9D is the reports generation user interface;

FIG. 10A-10B is the invention disclosure user interface;

FIG. 11A-11B is the All DealRooms interface of the virtual deal room;

FIG. 12 is the edit view of a selected virtual deal room;

FIG. 13A-13B is the edit view of a selected virtual deal room, with the Patent Records selection tab in view;

FIG. 14 is the edit view of a selected virtual deal room, with the Supporting Files selection tab in view;

FIG. 15A-15C is the viewer interface of a completed virtual deal room, available via the editor and via link as a view-only or limited-view document;

FIG. 16A-16B is an encrypted URL provided via the share function of a particular virtual deal room;

FIG. 17A-17E is the user interface of the analytics dashboard using the data produced by the Machine Learning Analytics Engine.

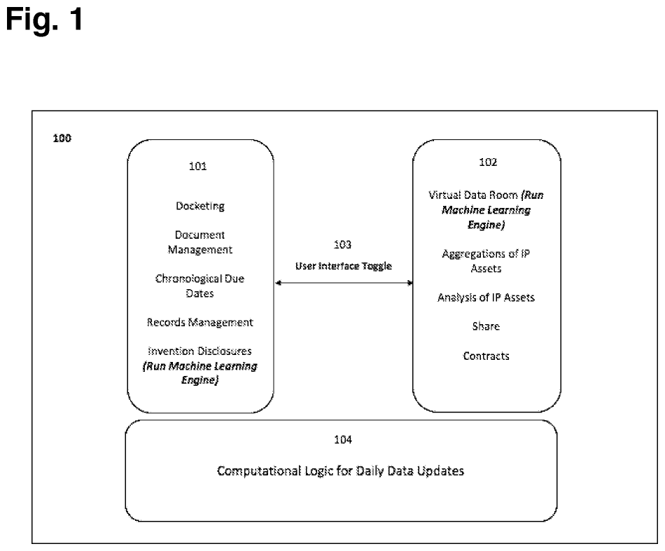

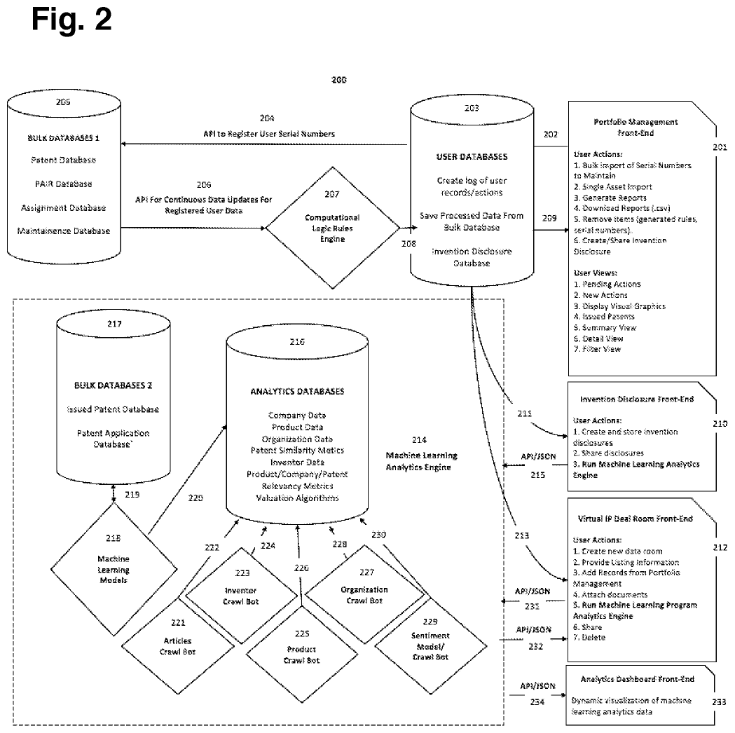

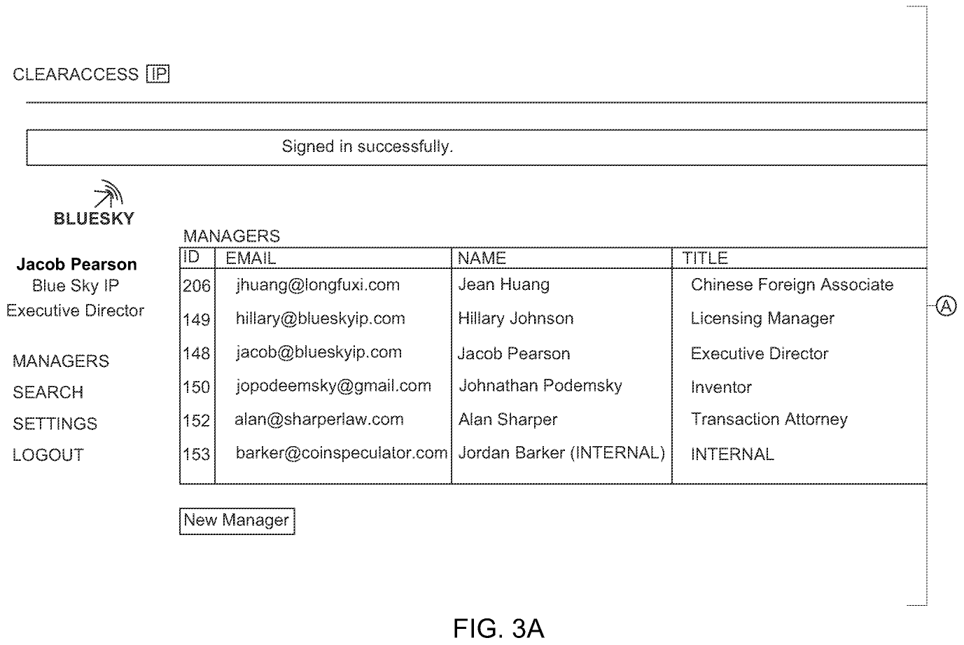

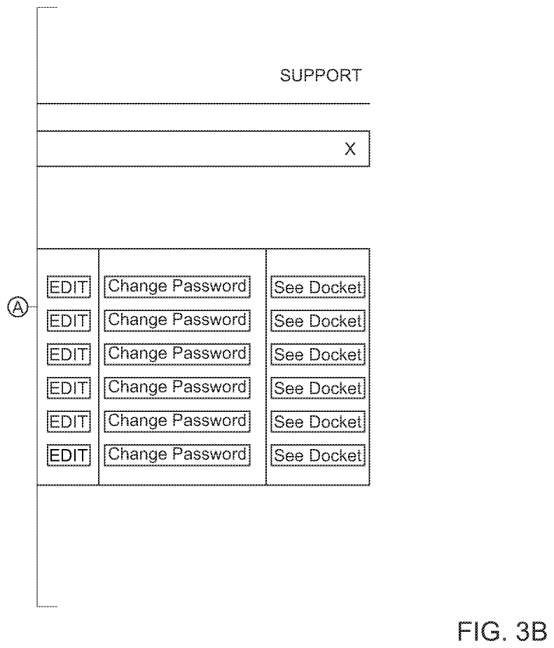

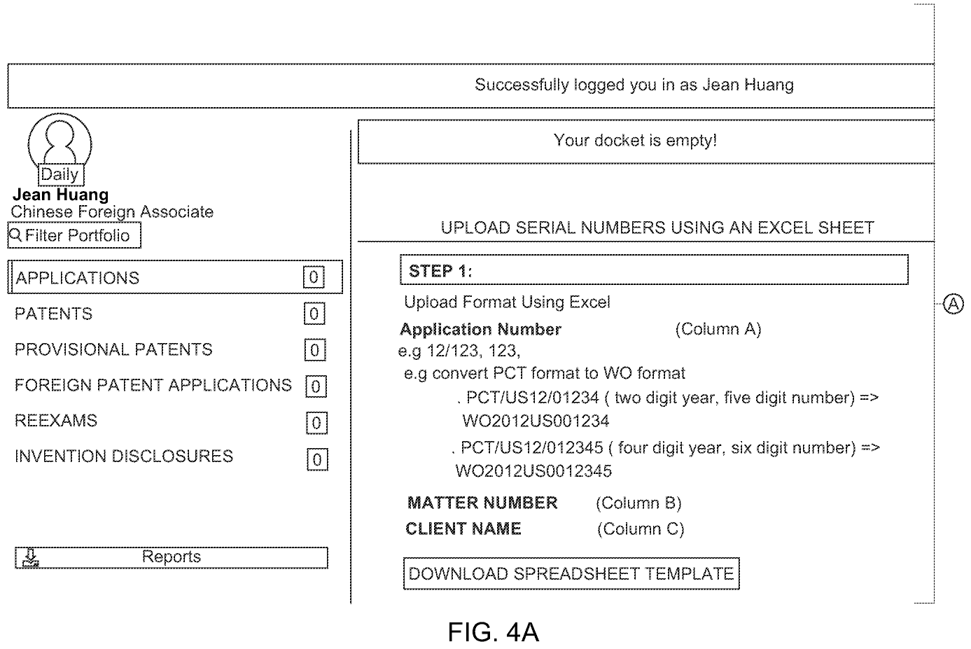

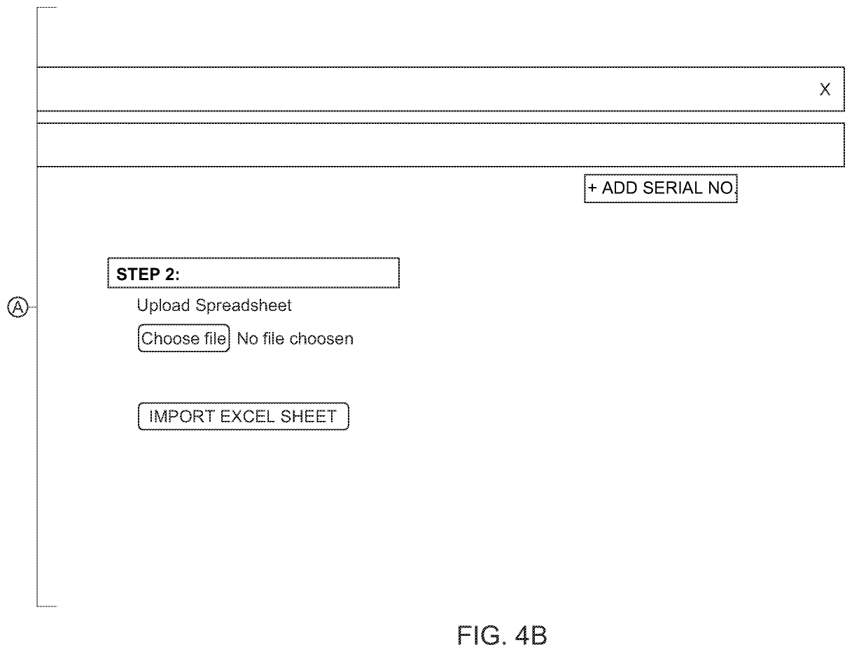

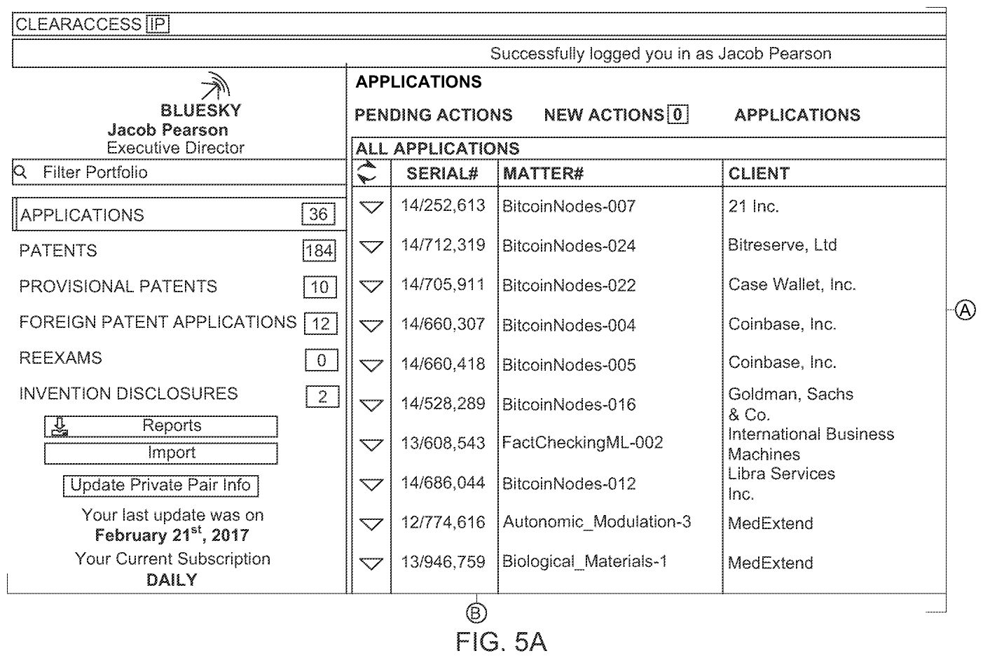

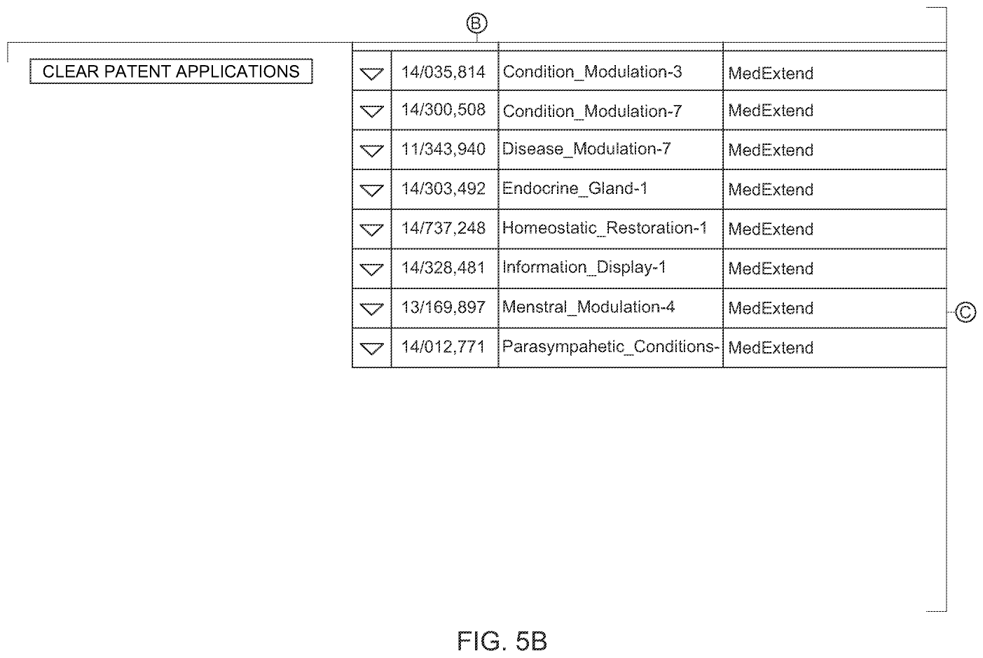

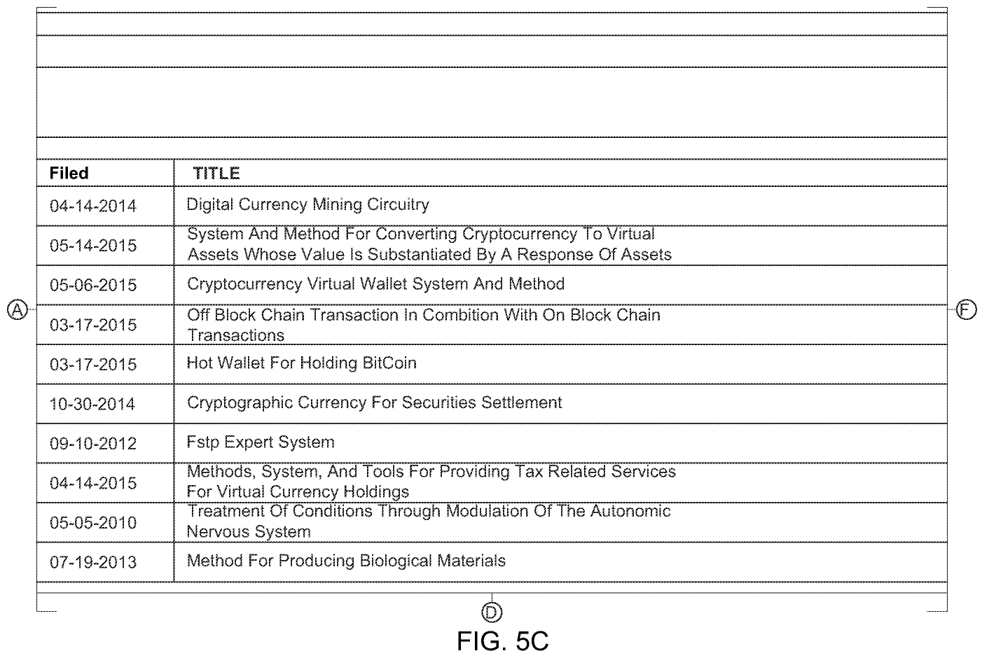

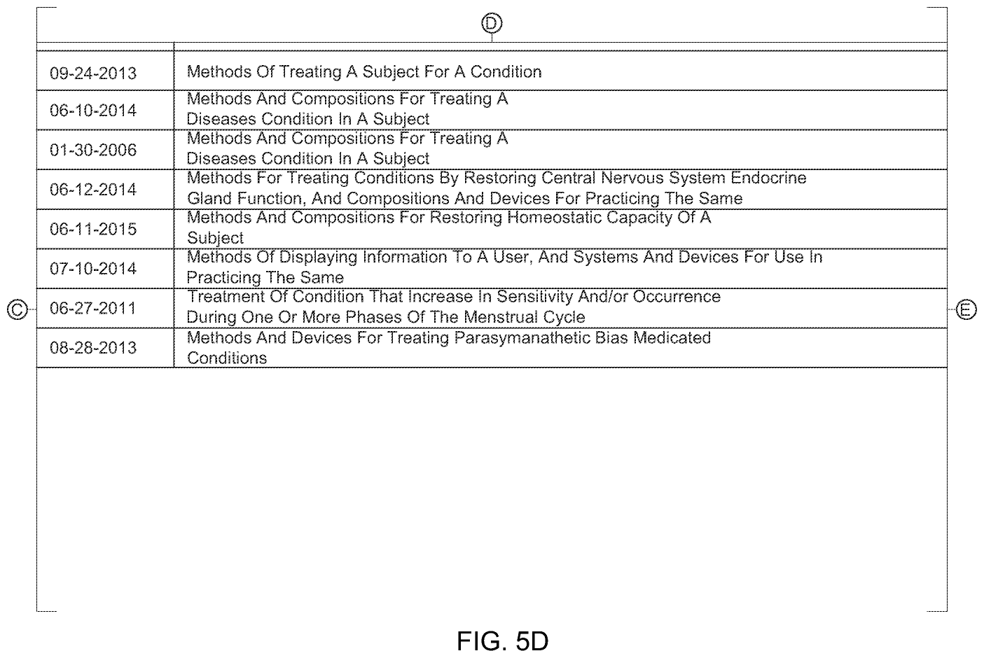

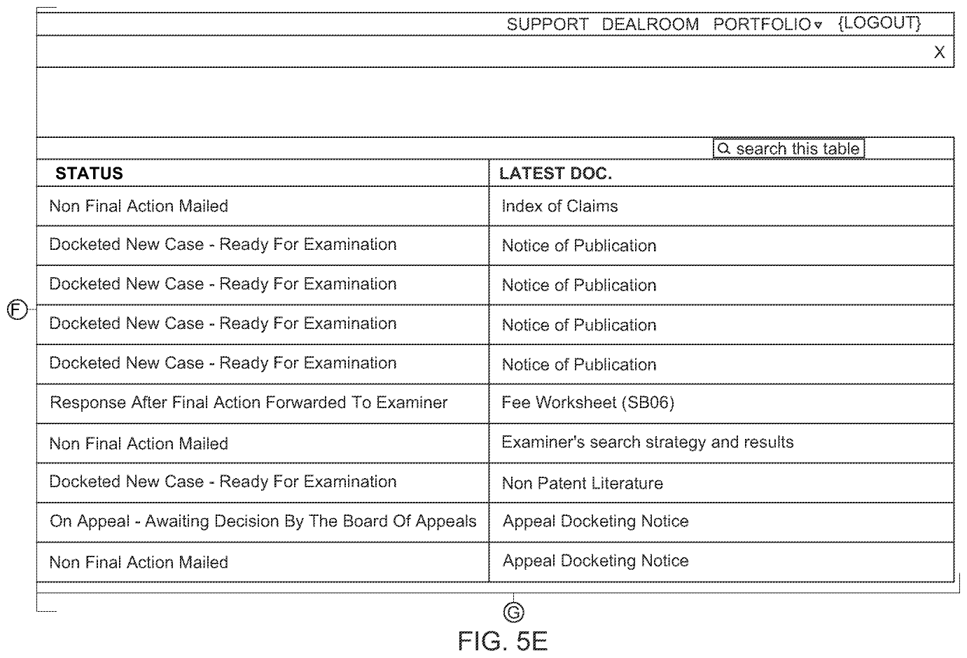

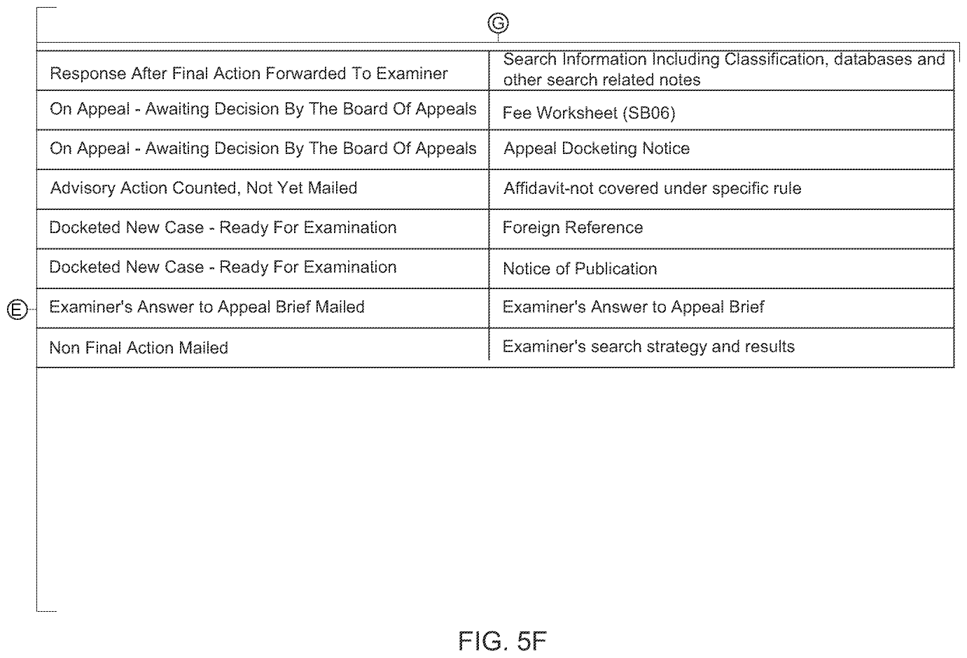

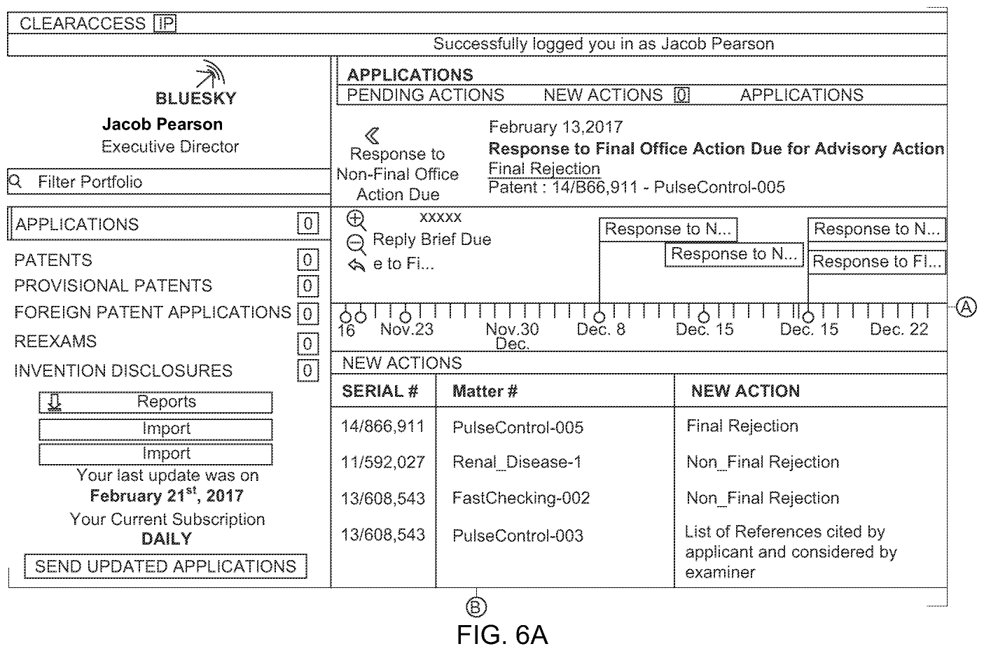

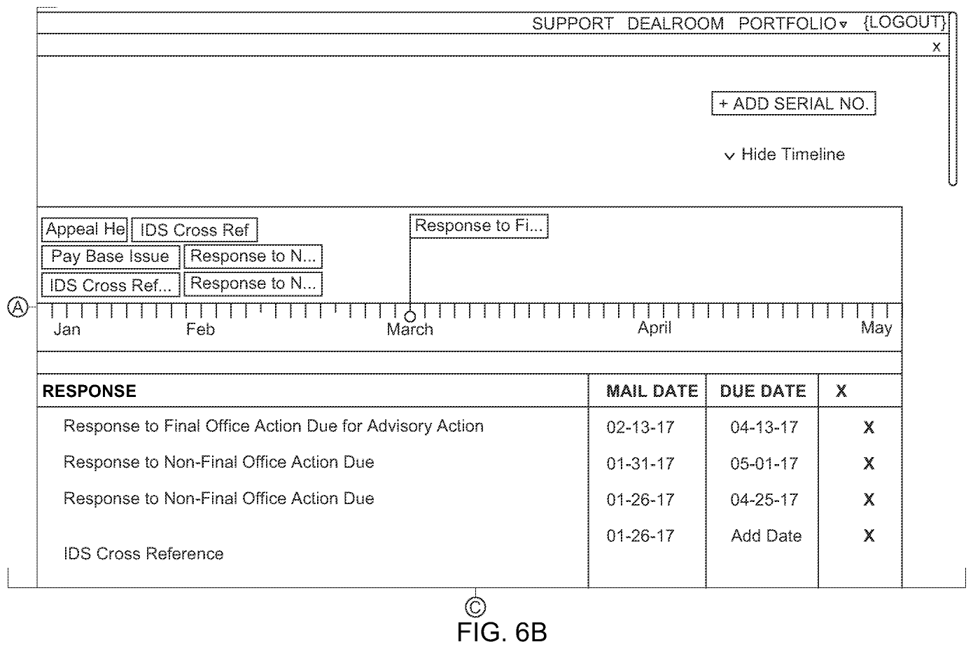

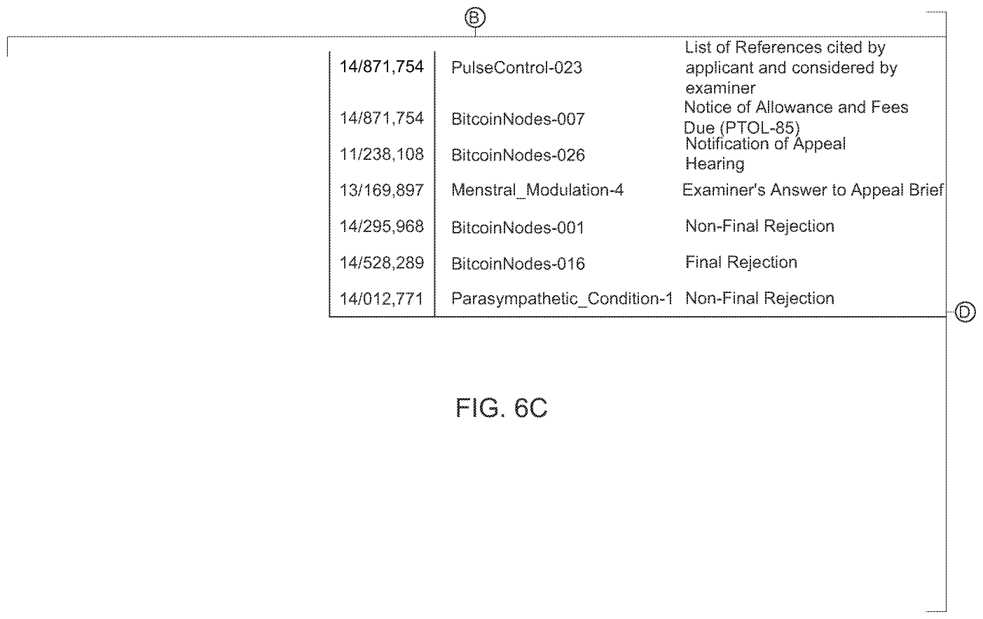

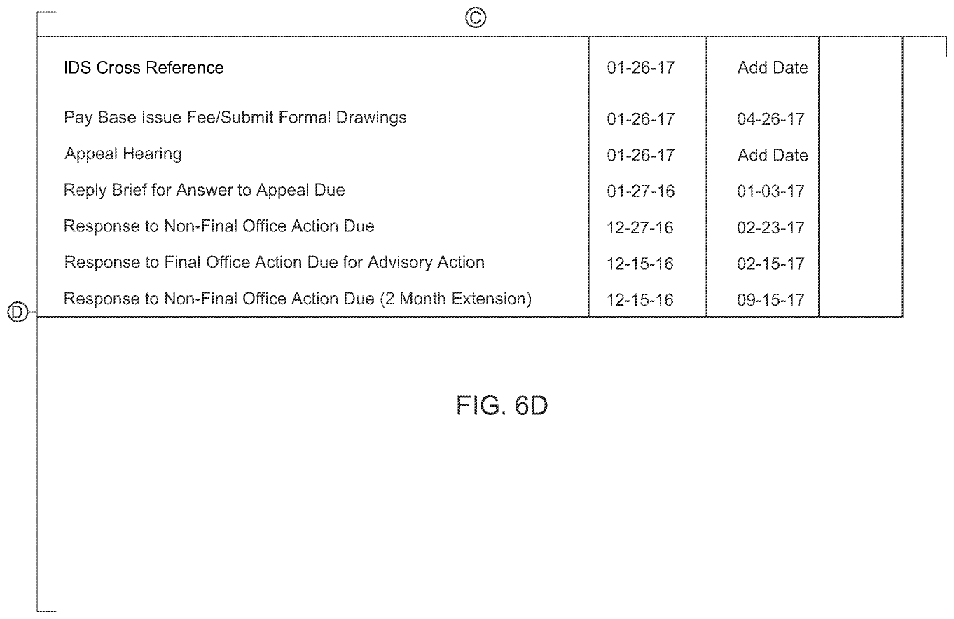

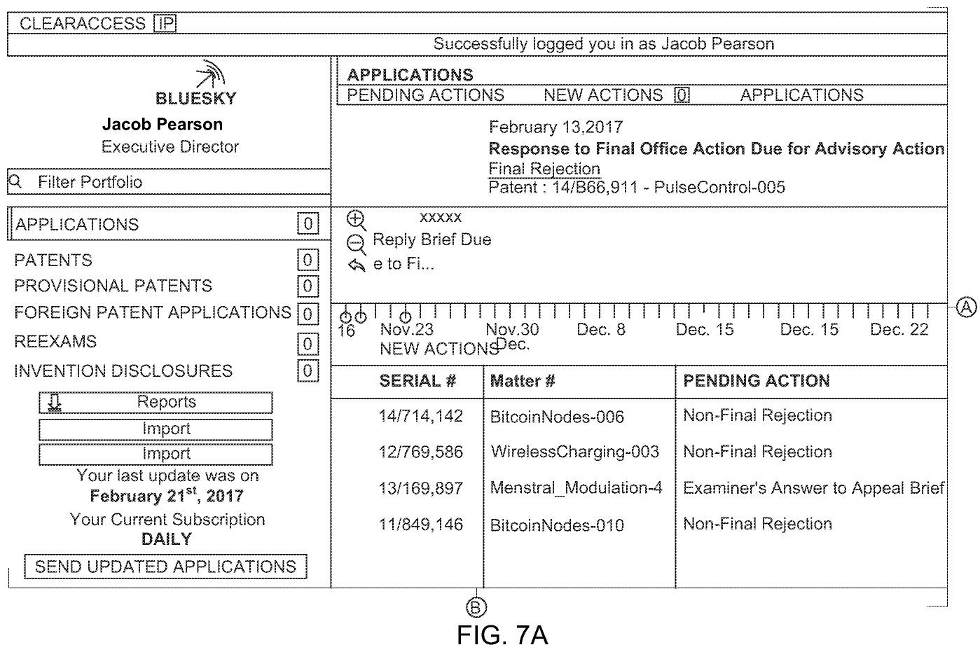

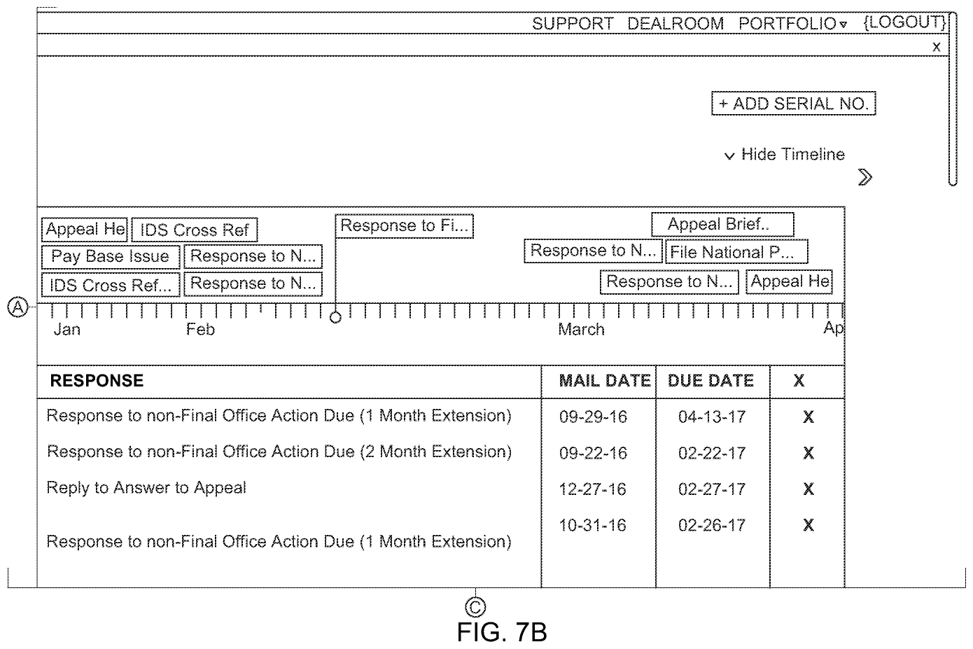

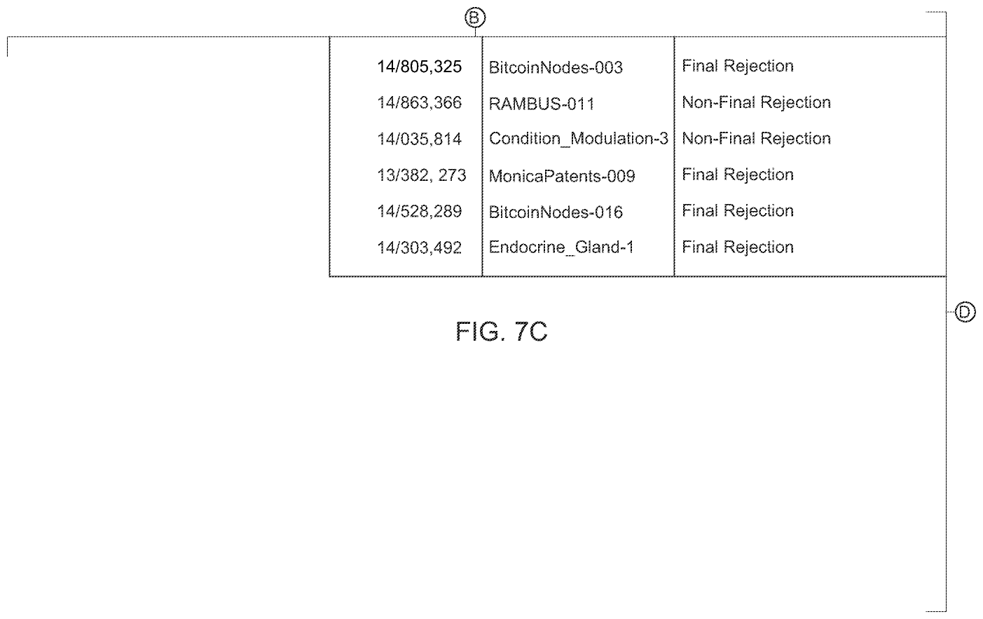

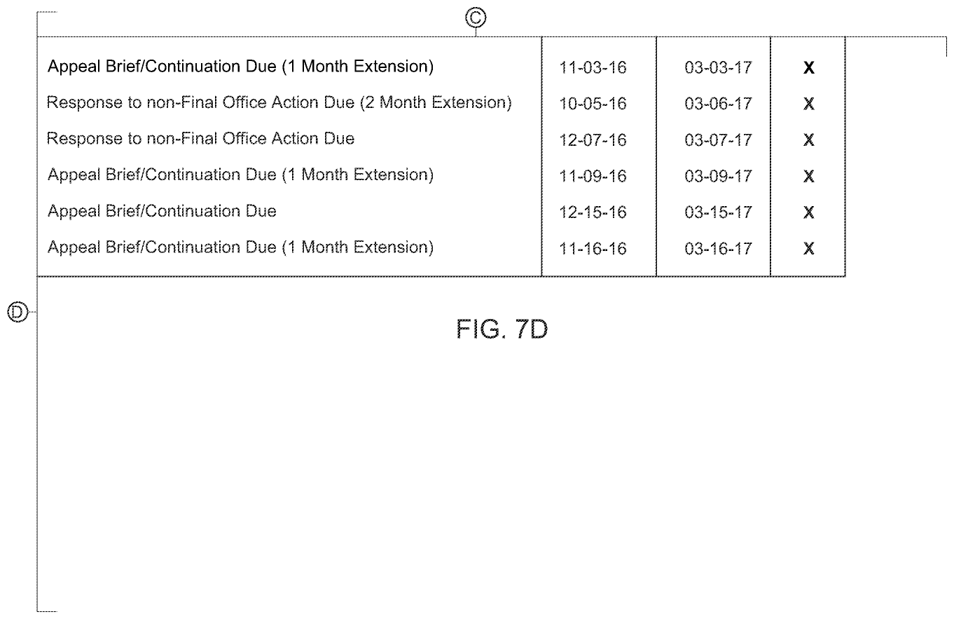

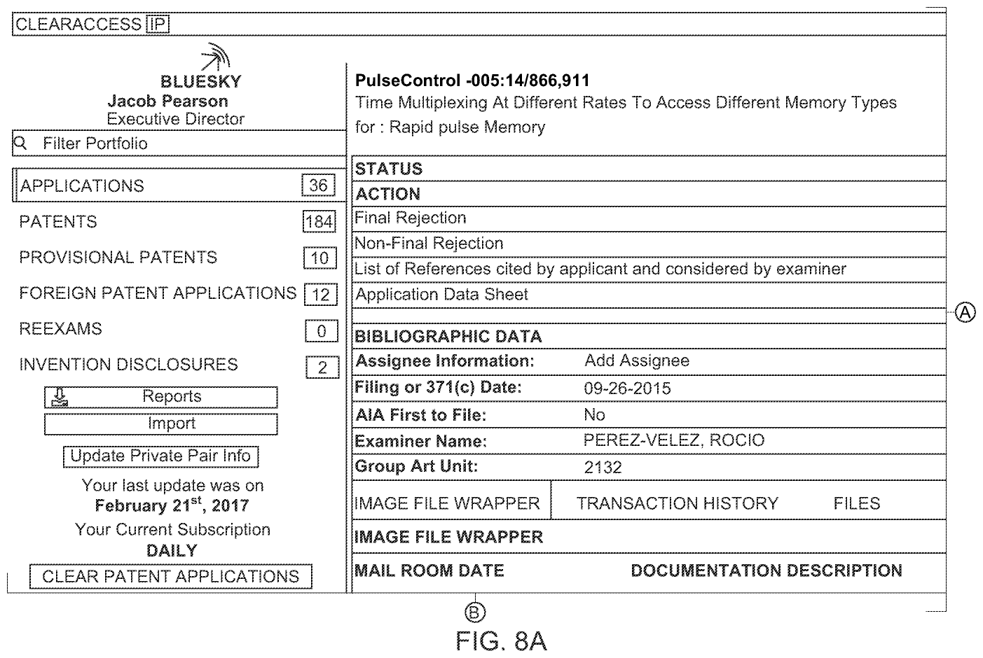

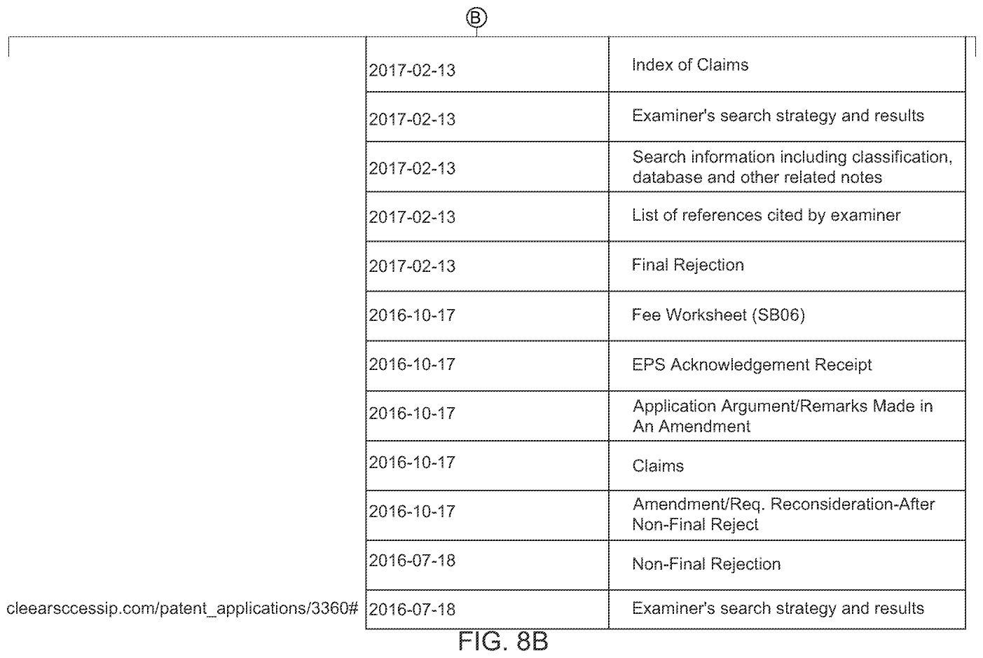

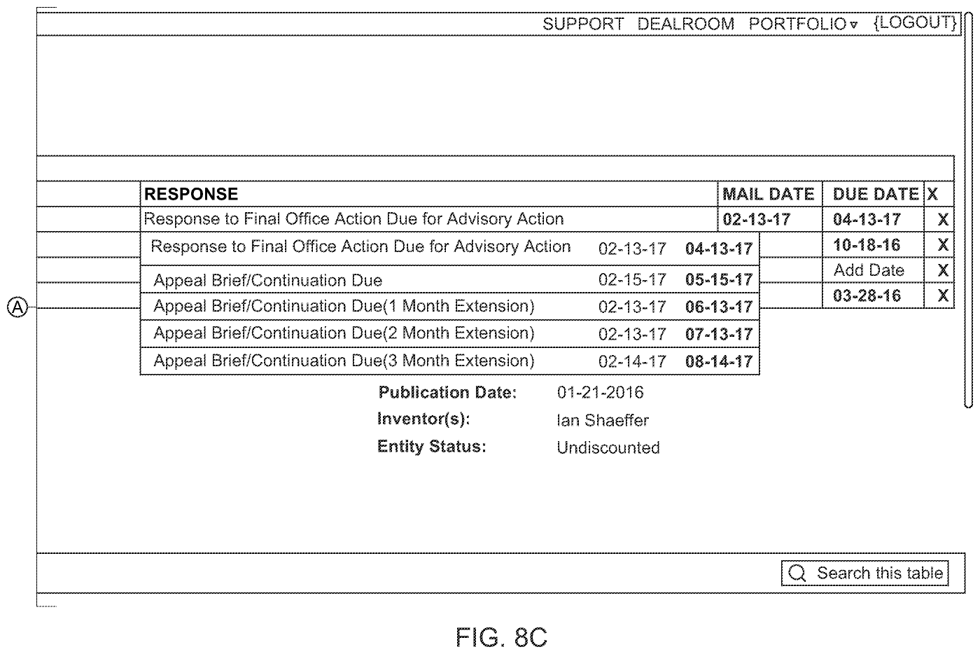

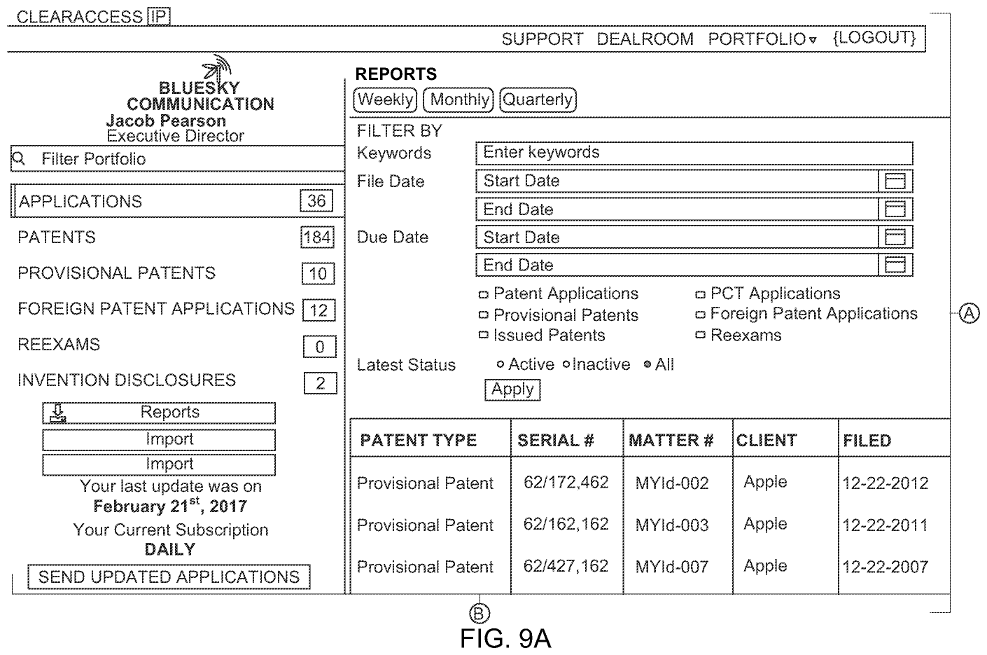

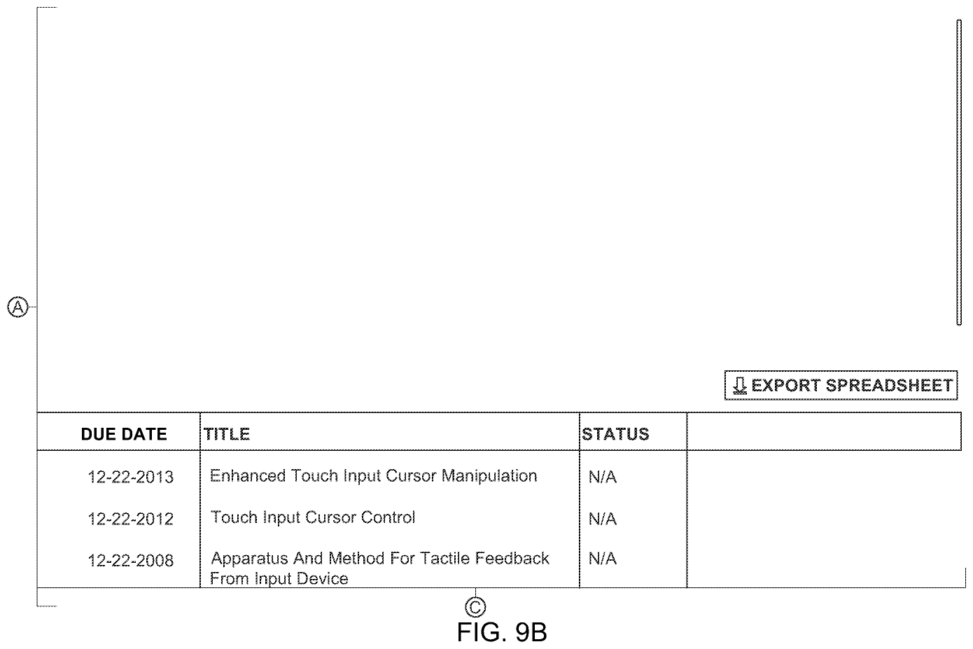

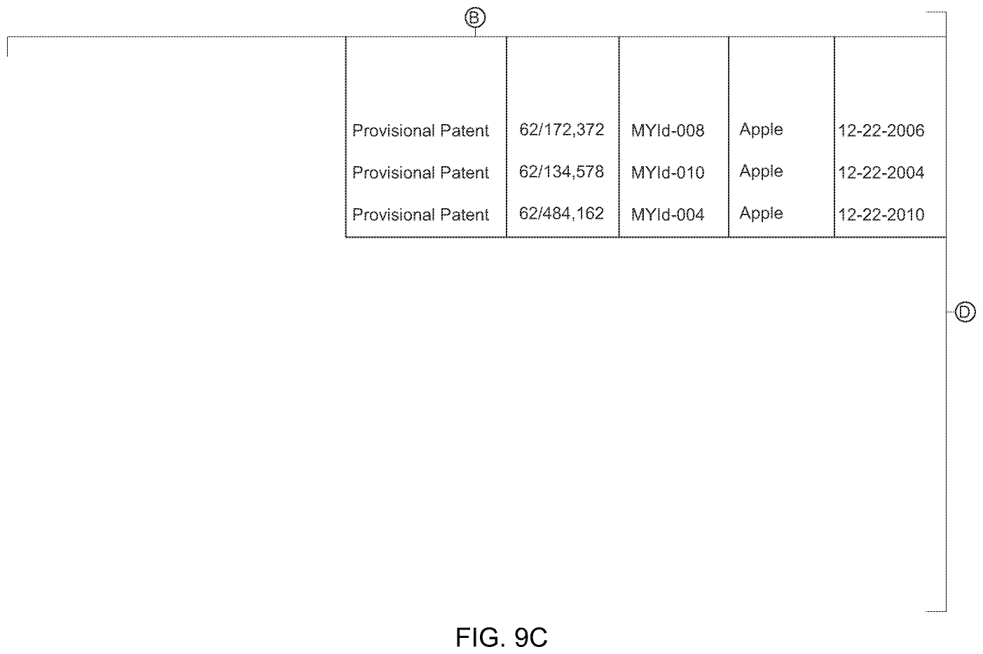

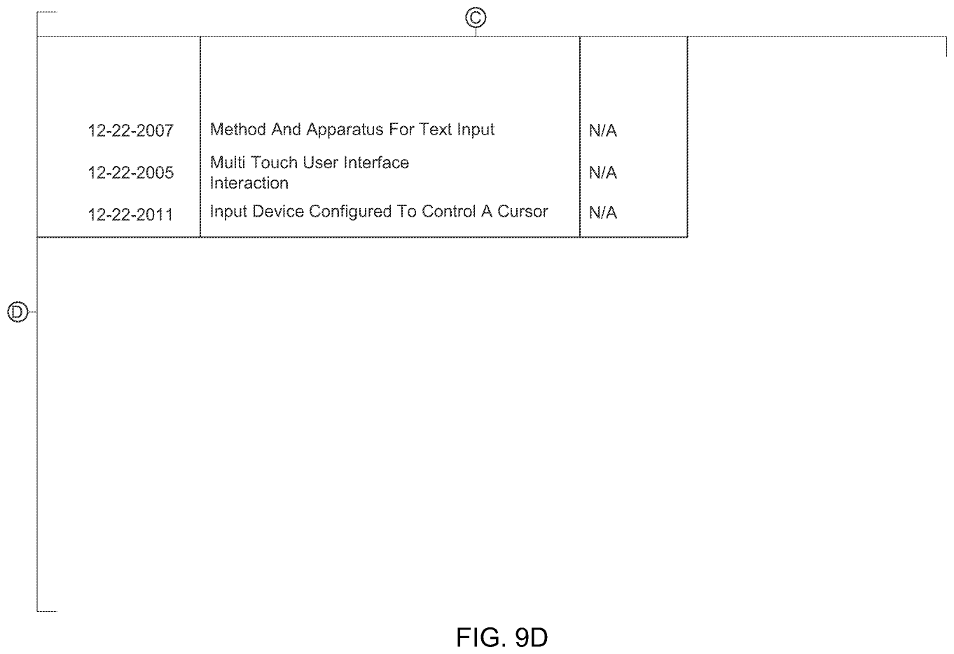

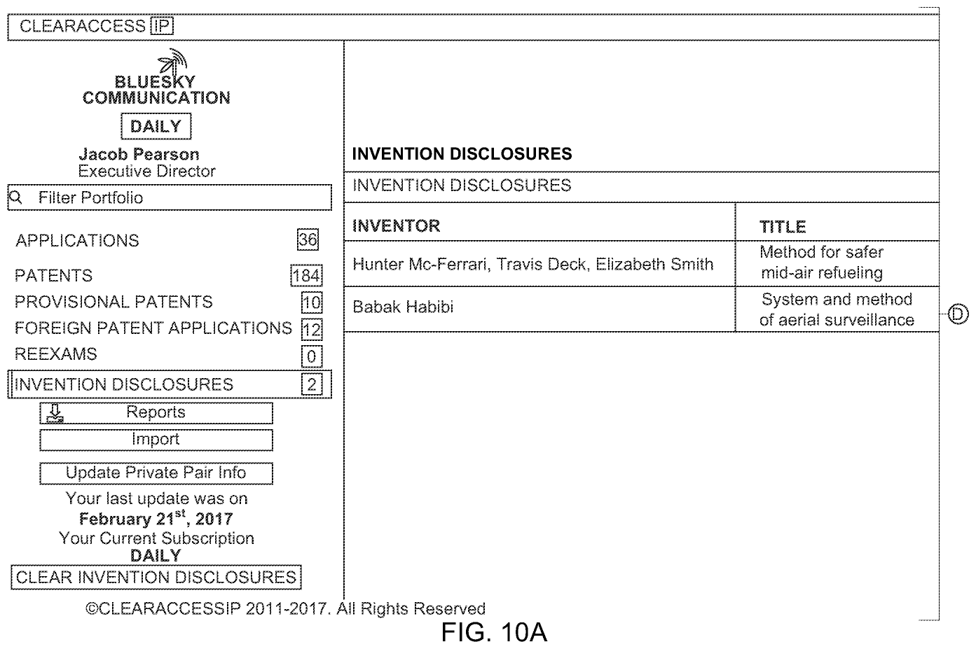

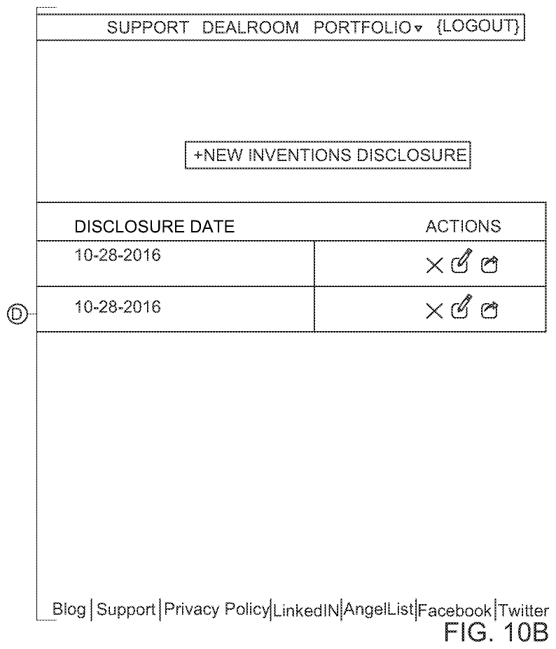

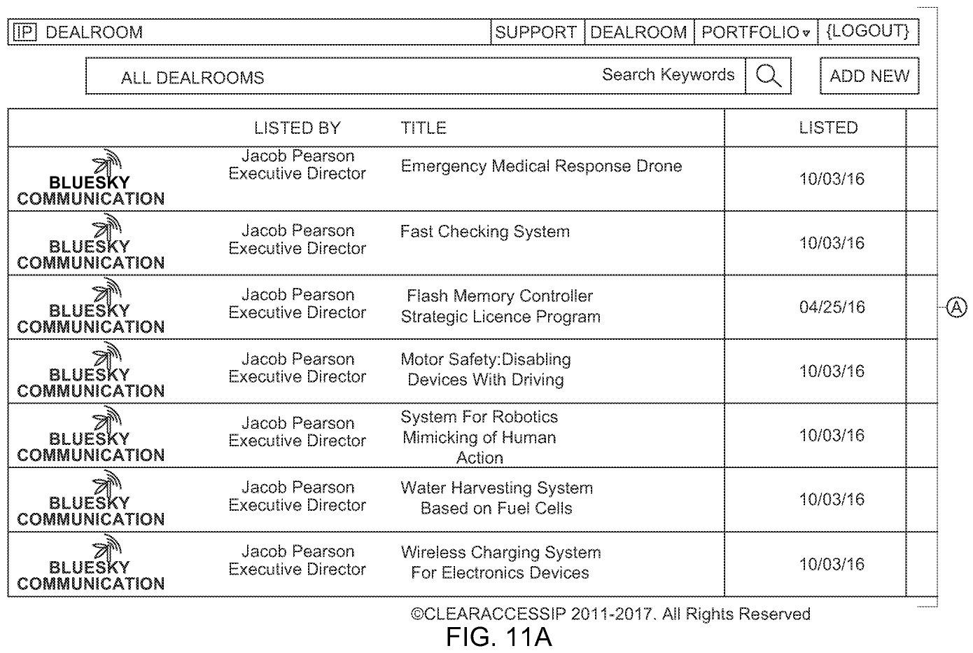

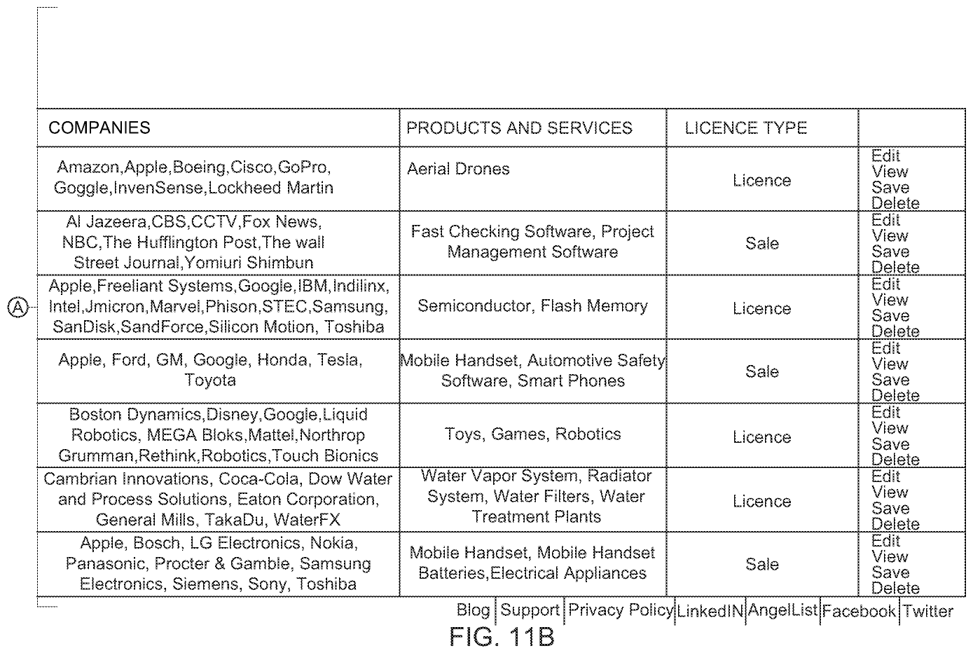

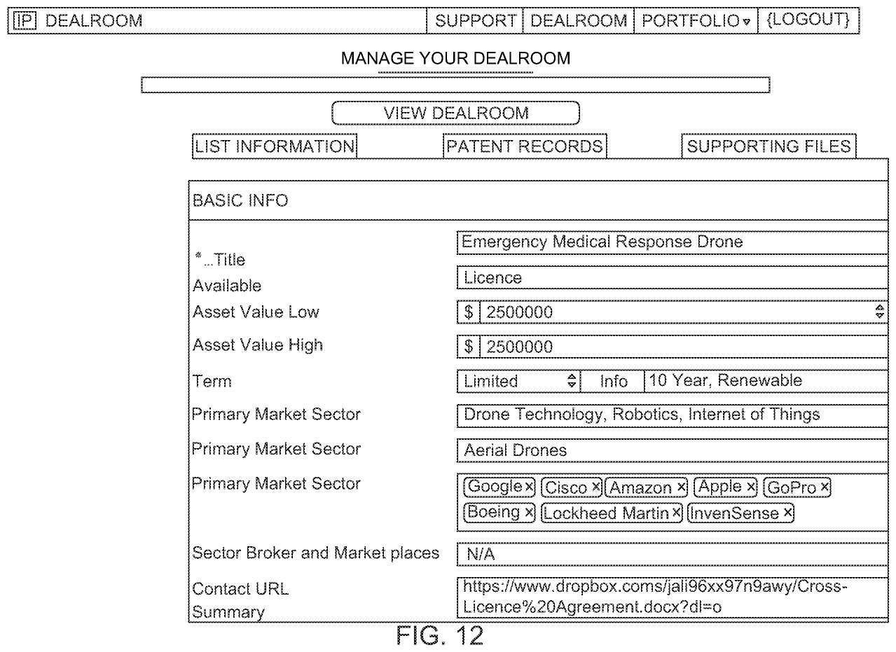

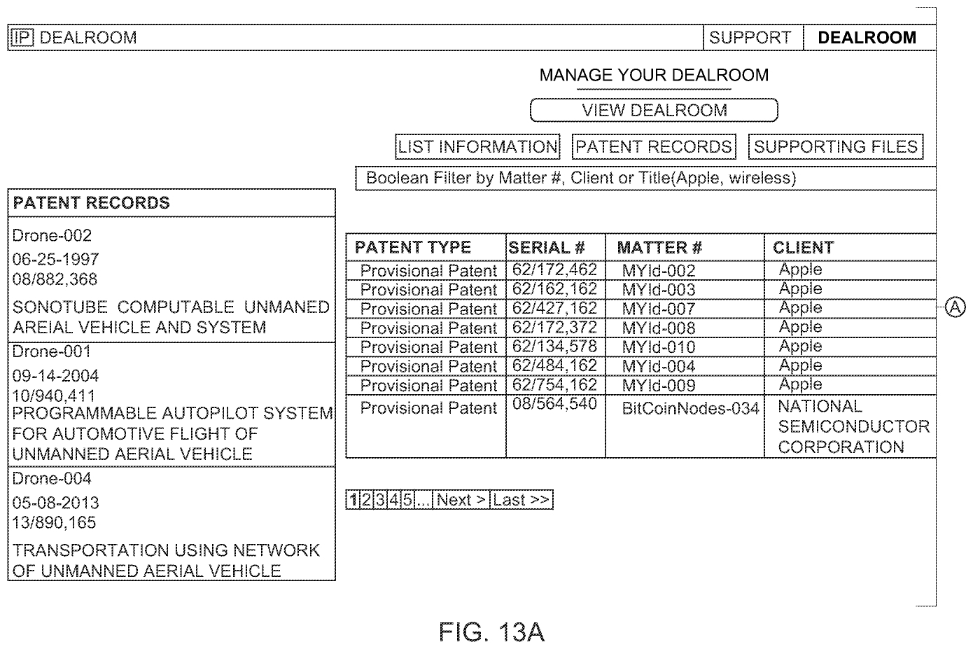

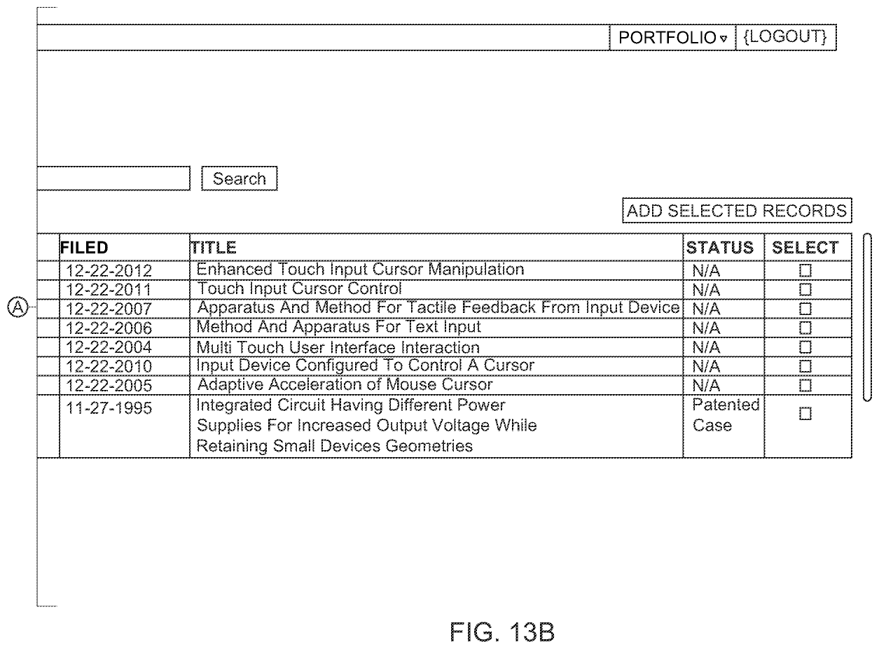

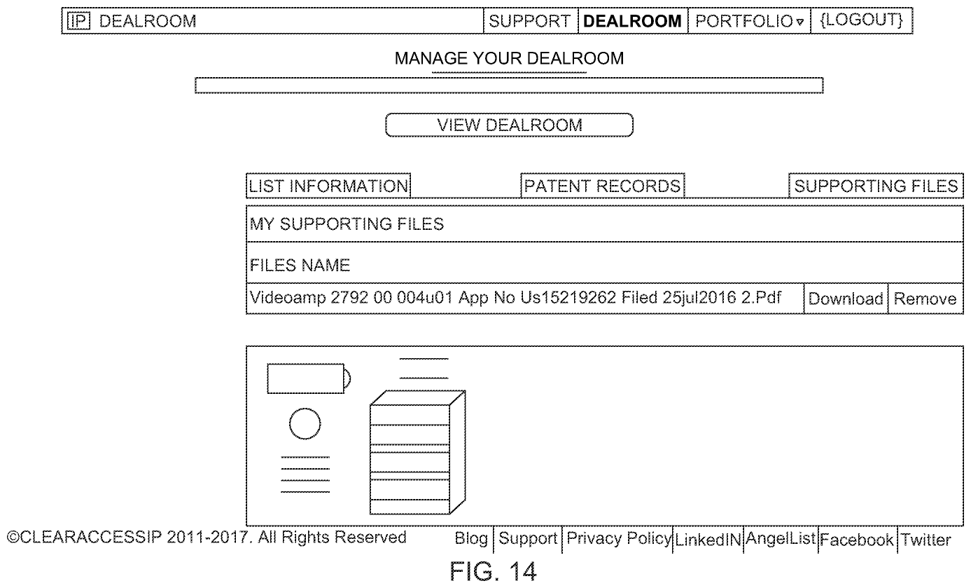

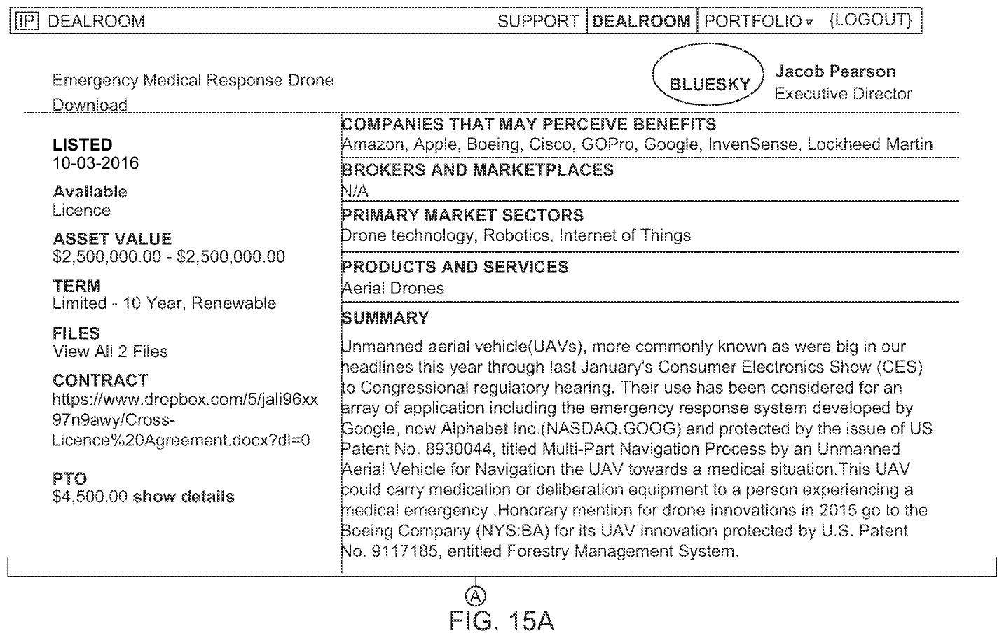

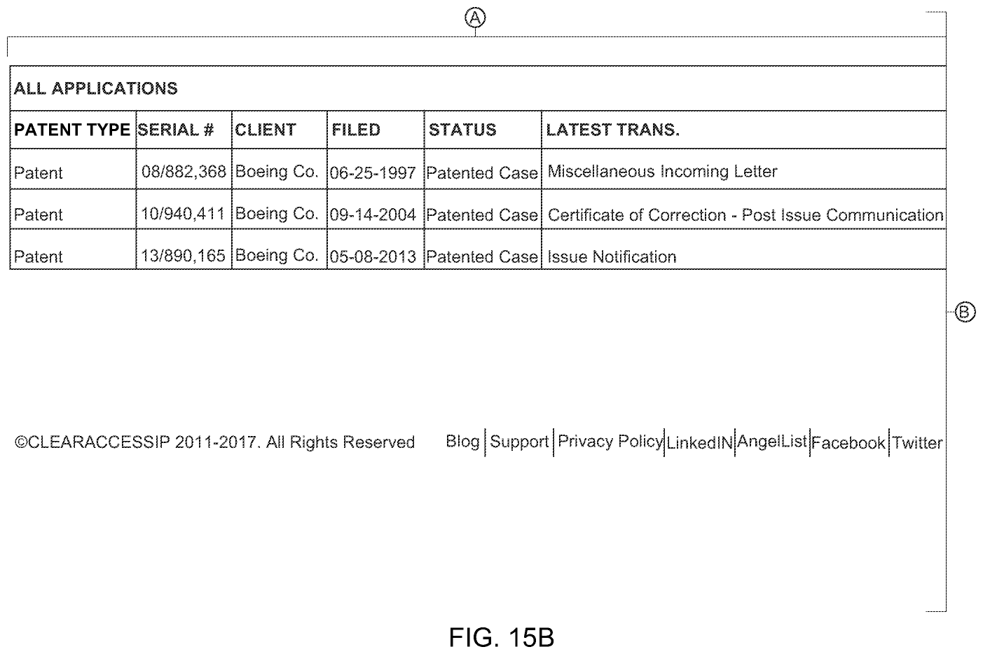

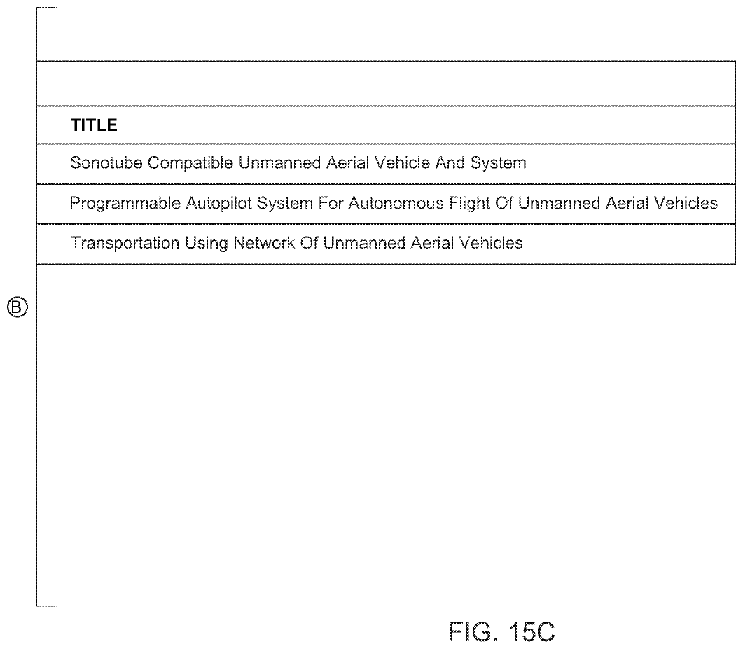

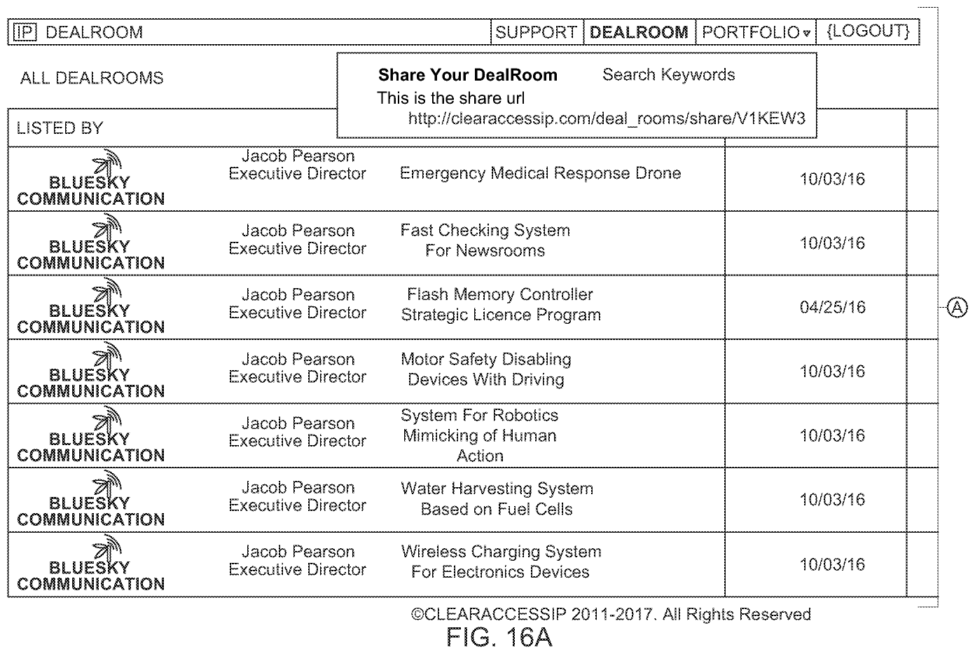

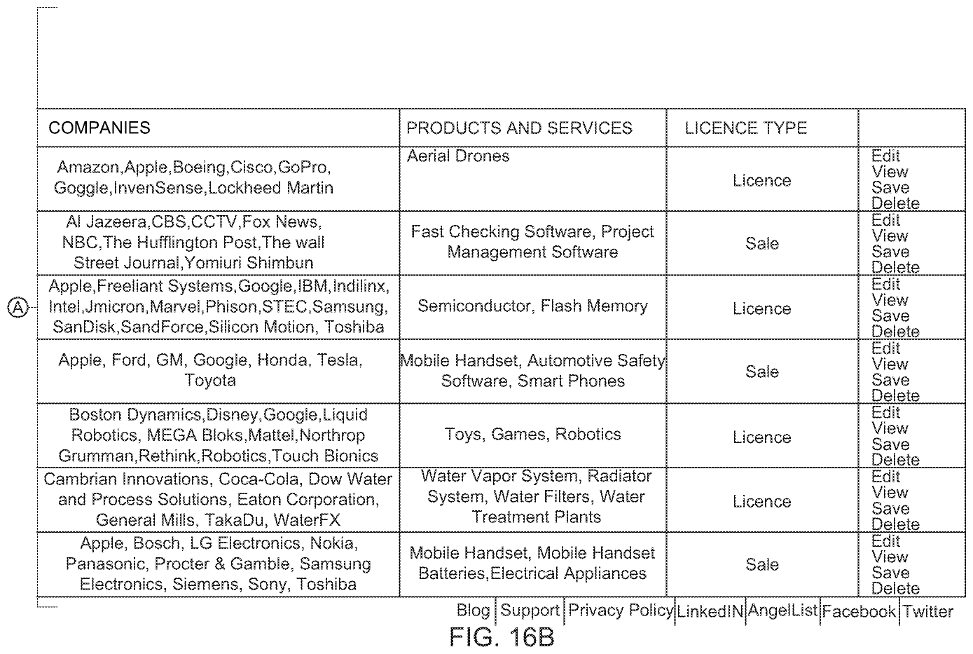

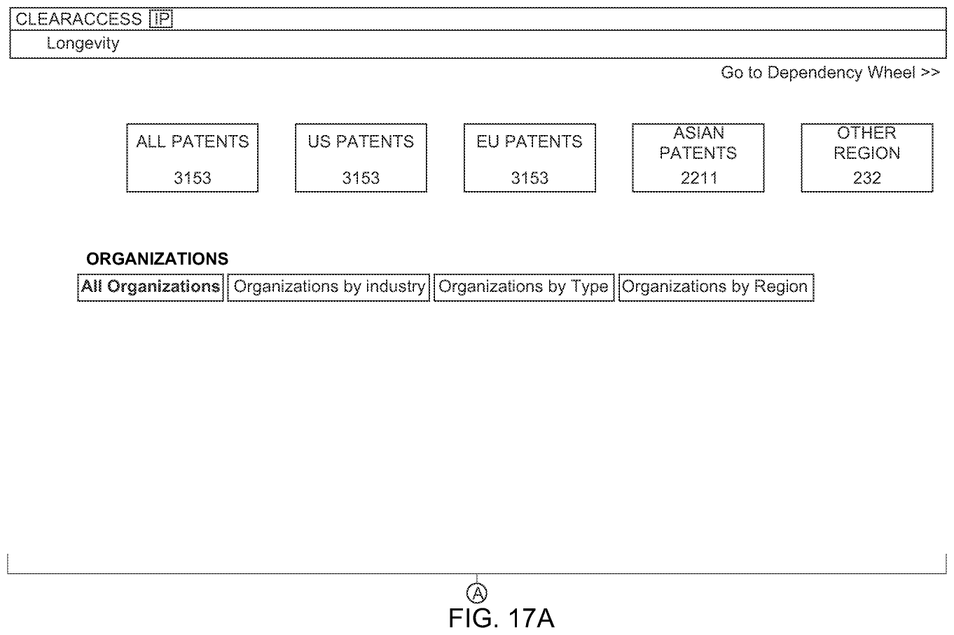

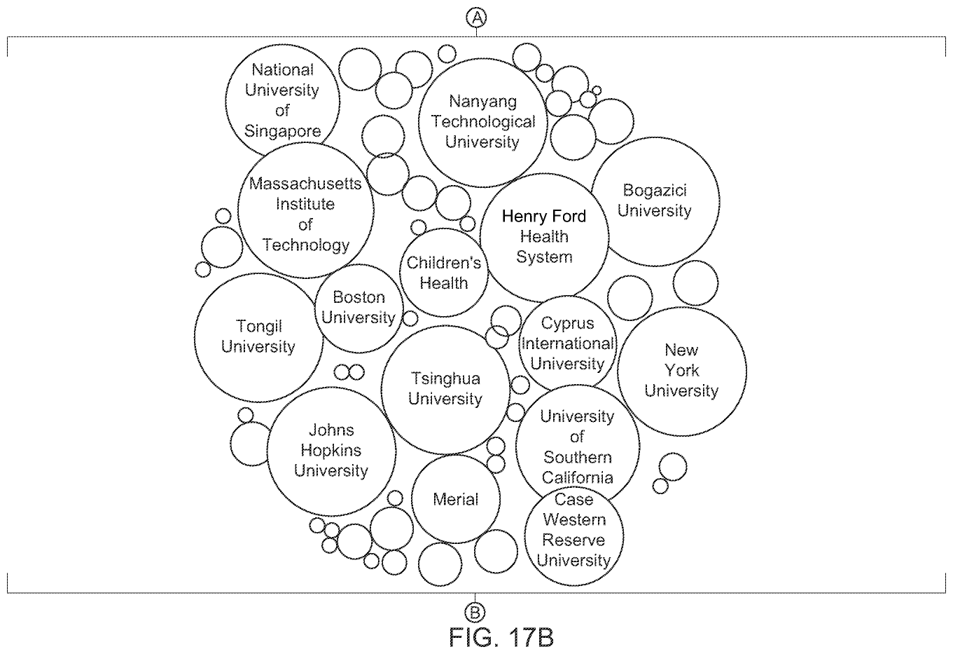

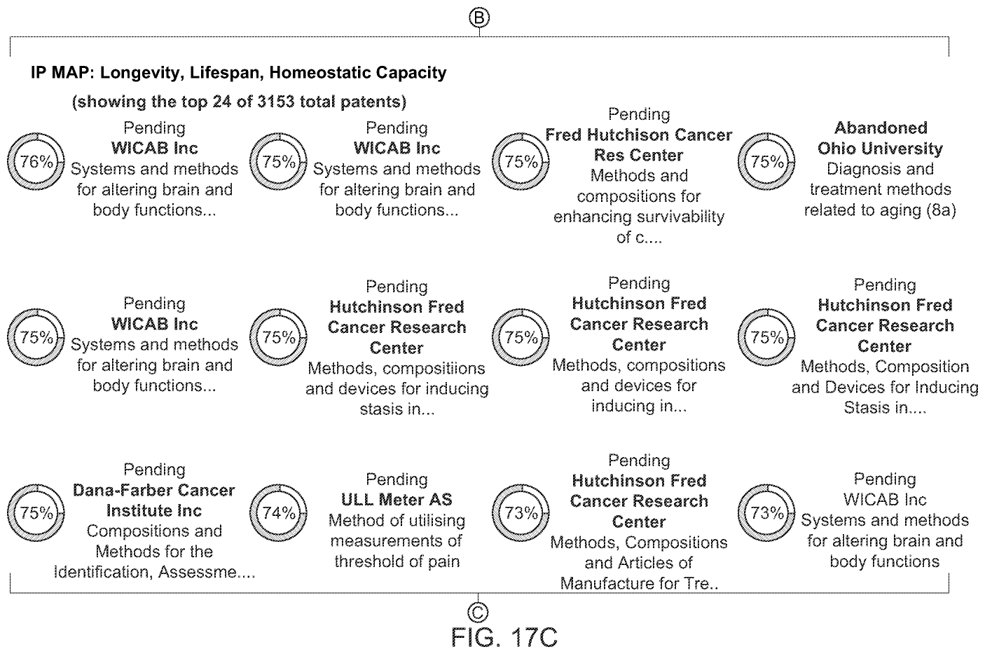

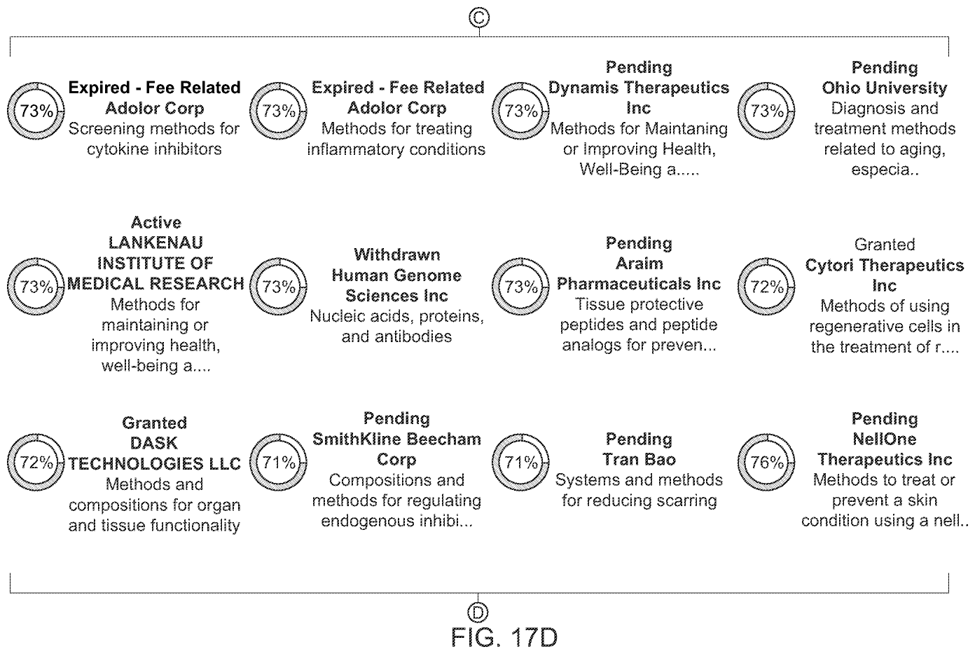

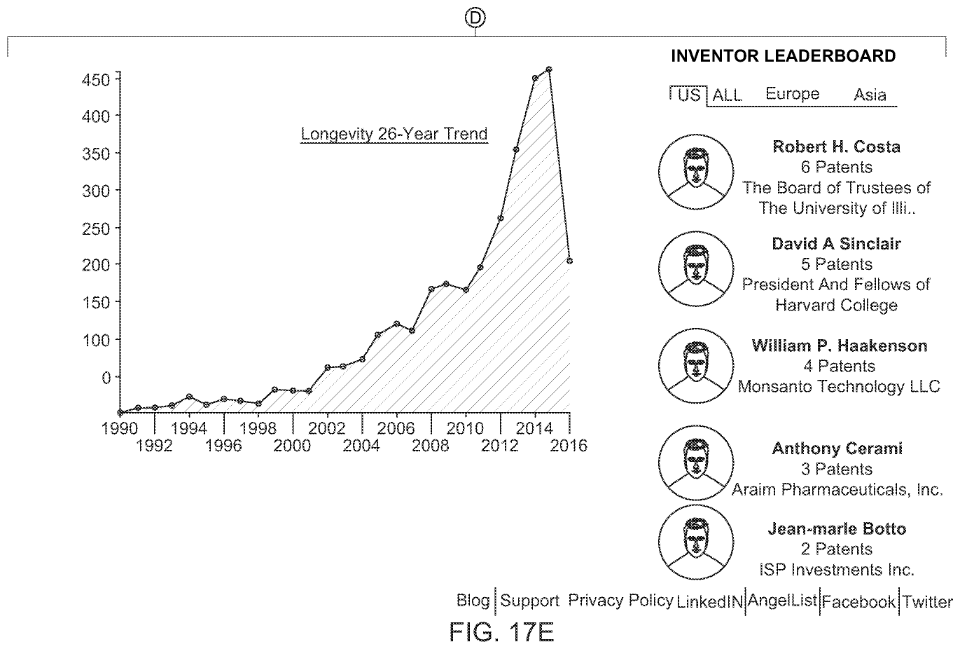

### DETAILED DESCRIPTION OF THE PREFERRED EMBODIMENT

The following is a detailed description of illustrative embodiments of the present invention. As these embodiments of the present invention are described with reference to the aforementioned drawings, various modifications or adaptations of the methods and or specific structures described may become apparent to those skilled in the art. All such modifications, adaptations, or variations that rely upon the teachings of the present invention, and through which these teachings have advanced the art, are considered to be within the spirit and scope of the present invention. Hence, these descriptions and drawings are not to be considered in a limiting sense as it is understood that the present invention is in no way limited to the embodiments illustrated.

In some embodiments, the machine learning enabled platform comprises a machine learning model stored in memory. The machine learning model is trained on a plurality of patents owned by patent owners and the plurality of patents contains inventions. The machine learning model is coupled to a processing device operatively coupled to memory comprising instructions, wherein the processing device is configured to receive an input from a partner, the input including an identity of the partner and associated with an invention described in a patent upon which the machine learning model is trained, query the machine learning model to output an identity of at least one patent owner associated with the invention, receive a notification from the patent owner associated with the invention indicating a willingness to transact the patent, match the partner and the patent owner based on an identity of the partner and an identity of the patent owner, initiate a real-world discussion between the patent owner and the partner regarding the invention described in the first patent; and mediate the real-world discussion by providing a secure channel of communication between the patent owner and the partner within the platform.

According to the scope of the present disclosure, a “patent owner” is a legal entity or party exerting control or having ownership rights over a patent to exclude others from practicing the invention. The patent owner may be a single entity or multiple entities. The patent owner may be an inventor, applicant, assignee, or other entity listed in the metadata of the patent. Alternatively, the patent owner may be an owner that can be shown to have acquired the exclusionary right of the patent via chain of title, such as a mergers and acquisitions agreement or a license. The ownership stake to define a “patent owner” may have majority or minority interest in the rights associated with a patent. In some embodiments, a “patent owner” is an entity that has the right to sell or license the exclusionary right or exclusionary rights conferred by the patent.

According to the scope of the present disclosure, a “partner” is a legal entity or party not exerting control or having ownership rights in the patent. In some embodiments, a partner may wish to access the exclusionary rights to enhance their patent protection. In some embodiments, the partner may be one of several entities or parties exerting control or having ownership rights in the patent and may wish to acquire more control. It is contemplated that a single partner or multiple partners can express interest in acquiring patent rights to an invention.

According to the scope of the present disclosure, a “patent owner” and a “partner” may be individually or collectively referred to herein as “parties.” A patent owner is contemplated to be a user of the machine learning enabled platform discussed herein. Likewise, a partner is contemplated to be a user of the machine learning enabled platform discussed herein.

According to the scope of the present disclosure, a “patent” is contemplated to be an intellectual property asset that is drawn to an invention. A patent may be a nonprovisional application of any status. For instance, a patent may be active or inactive. A patent may be issued by a judicial authority, for example, the US Patent and Trademark Office. A patent may also be abandoned. A patent may be a pending application, whether published or not. A patent may be a provisional application. In some embodiments, a patent may also be considered an invention disclosure. The invention as contemplated may be a technology.

In some embodiments, the plurality of patents upon which the machine learning model is trained comprises the global patent corpus. Subsets of the global patent corpus may be used to train machine learning models. For instance, the plurality of patents on which the machine learning model may be trained can comprise United States patent corpus, which includes patents that are filed with the United States patent office as a first filing or are filed with the United States as a receiving office. Likewise, the plurality of patents upon which the machine learning model is trained can comprise select jurisdictions where patents are filed, such as the European Union, China, Japan, and Korea, where the corpus for each respective jurisdiction includes patents that are filed as a first filing with each respective office or are filed at this jurisdiction as a receiving office. It is contemplated that multiple corpuses can be selected, any combination thereof, or any subset of the global patent corpus falls within the scope of these embodiments.

The machine learning model as described herein is coupled to a processing device operatively coupled to memory comprising instructions, wherein the processing device is configured to receive an input from a partner, the input including an identity of the partner and associated with an invention described in a patent upon which the machine learning model is trained. The received input may be associated with an invention described in one or more patents on which the machine learning model is trained. In some embodiments, the received input includes an identity of a partner, who is the source of the input. The received input may include input information including a key phrase associated with the invention or describing the invention. The key phrase could be a noun phrase, a verb phrase, or a prepositional phrase, or any combination thereof. The received input may include a second patent describing the invention. The received input may include metadata associated with the patent, such as the application number, serial number, publication number, patent number, or any combination thereof.

The received input may include free form or natural language text, as is understood by a person of ordinary skill in the art of machine learning. The received input may include associated with the invention is a description of a product, written in natural language text.

In some embodiments, the received input is stored in a database and communicated to the partner via a front-end virtual data room (or virtual deal room). The received input may be stored in an analytics database or a user database. The received input may hide the identity of the partner from the patent owner.

The machine learning model as described herein is coupled to a processing device operatively coupled to memory comprising instructions, wherein the processing device is configured to query the machine learning model to output an identity of at least one patent owner associated with the invention. In some embodiments, the query can be executed in runtime.

The machine learning model as described herein is coupled to a processing device operatively coupled to memory comprising instructions, wherein the processing device is configured to receive a notification from a patent owner associated with the invention indicating a willingness to transact the patent. t is contemplated that the machine learning model can return a single patent owner or multiple patent owners associated with the invention. In some embodiments, the received notification indicates the patent owner's willingness to sell the patent, to license the patent, or to cross-license the patent. Multiple types of complex deal structures are contemplated to be within the scope of these embodiments.

In some embodiments, the received notification is stored in a database until a second notification is received that a partner indicates willingness to buy the patent. It is contemplated that any length of time may pass before the second notification from a partner indicating a willingness to buy the patent is received. This length of time may be days, weeks, months, years, immediately before, immediately after, or contemporaneous. The second received notification from the partner may indicate the partner's willingness to buy the patent, license the patent, or cross-license the patent.

The machine learning model as described herein is coupled to a processing device operatively coupled to memory comprising instructions, wherein the processing device is configured to register a match between the partner and the patent owner based on an identity of the partner and an identity of the patent owner. The platform may register a match between the patent owner and the partner upon receipt of the first and second notifications. The platform is contemplated to support matches between a patent owner and multiple partners. The match may be stored in an analytics database coupled to or part of the machine learning enabled platform.

In some embodiments, the match may be registered if the patent owner has whitelisted the identity of the partner from a list of partner identities generated from the output of the machine learning model. Alternatively, the match may be registered if the partner has whitelisted the identity of the patent owner from a list of patent owner identities. It is contemplated that each patent owner may have whitelisted multiple identities associated with distinct partners and each partner may have whitelisted multiple identities associated with distinct patent owners. It is also contemplated that multiple whitelists may be associated with a patent. The matches may be registered by their respective parties based on data shown visually to the party, which may include a model output of the machine learning model, a product crawlbot, and/or an articles crawlbot. In some embodiments, the data shown visually is stored in a virtual data room and accessible to the party and shareable outside the platform. Once a match has been registered, the match may be visually represented to the parties in the virtual data room.

In some embodiments, the match may not occur if the patent owner has not whitelisted the identity of the partner. Likewise, the match may not occur if the partner has not whitelisted the identity of the patent owner. The whitelist generated by the partner may be stored in an analytics database. Likewise, wherein the whitelist generated by the patent owner may be stored in an analytics database.

In some embodiments, it may be desirable on the part of the partner to obscure their identity and inquire anonymously as to a patent owner's willingness to transact. As such, the match may hide, obscure, or conceal the identity of the partner from the patent owner. In some embodiments, it may be desirable on the part of the patent owner to obscure their identity and inquire anonymously as to a partner's willingness to transact. As such, the match may hide, obscure, or conceal the identity of the patent owner from the partner.

In these embodiments, the party initially hiding, obscuring, or concealing their identity may then grant permission. The permission may be granted in a subsequent notification to the machine learning enabled platform. The match may be updated to reveal the identity of the partner to the patent owner based on a permission granted by the partner. Likewise, the match may be updated to reveal the identity of the patent owner to the partner based on a permission granted by the patent owner. It is contemplated that the identity of the partner may remain unknown to the patent owner due to the partner's choice to keep their identity concealed, and that the partner identity is concealed throughout discussions, negotiations, and the like, even to the point of making a deal. Likewise, it is also contemplated that the patent owner may remain unknown to the partner, for example, if the patent has been traded or licensed. In a preferred embodiment, both the partner and the patent owner give permission to the platform to reveal their respective identities to the other party.

It is contemplated that the patent owner and/or the partner may whitelist several parties. For instance, a partner may also be a patent owner and vice versa, depending on the nature of transactions in patent rights in which the party intends to engage. As such, the match and identity reveal of the parties to each other may be known only to those parties and to the platform, such as a platform administrator. Patent owners otherwise associated with the invention may not be informed of the whitelists, matches, identities of the parties, reveals of identities, discussions, or transactions, unless the parties make these activities public. As such, the scope of activities described herein is contemplated to be confidential between the patent owner, partner, and platform administrator.

In some embodiments, permission may be granted to reveal the identities of each party upon a showing of good faith between the parties. For example, an authorized representative associated with the partner and an authorized representative associated with the patent owner can enter into an agreement as part of a good-faith showing with the platform administrator. The parties may also contract with each other, and in some cases, notify the platform administrator of the agreement. Examples of such agreements may include a Terms of Service, code(s) of conduct, subscription agreement, confidentiality agreement, non-disclosure agreement, or the like. Agreements that demonstrate good faith may be contracts which may or may not be legally binding on either party or on the administrator of the machine learning enabled platform. These agreements, permissions, and revealed identities may be stored in a virtual data room, accessible to the party granting permission. In some embodiments, both parties have access to at least one virtual data room.

The machine learning model as described herein is coupled to a processing device operatively coupled to memory comprising instructions, wherein the processing device is configured to initiate a real-world discussion between the patent owner and the partner regarding the invention described in the patent. In some embodiments, the real-world discussion is initiated after a reveal of the identity of the partner to the patent owner and/or after a reveal of an identity of the patent owner to the partner. It is also contemplated that real-world discussions may be initiated before a reveal of an identity of the patent owner to the partner. It is also contemplated that a full transaction of patent rights may take place with one party's identity remaining hidden, concealed, or obscured over the course of discussions and through an eventual transaction. It is contemplated that a reveal of an identity of a first party to a second party may be based on a permission granted by the first party.

In some embodiments, the real-world discussion is initiated after an authorized representative associated with the partner and an authorized representative associated with the patent owner have entered into an agreement. An agreement as contemplated may be made between the parties or between a party and an administrator of the machine learning enabled platform. Agreements such as a non-disclosure agreement (NDA), confidential disclosure agreement (CDA), terms of service, code(s) of conduct, and the like are contemplated within the scope of the invention. In some embodiments, agreements may be contracts which may or may not be legally binding on either party or on the administrator of the machine learning enabled platform.

The machine learning model as described herein is coupled to a processing device operatively coupled to memory comprising instructions, wherein the processing device is configured to mediate the real-world discussion by providing a secure channel of communication between the patent owner and the partner within the platform. In some embodiments, the secure channel of communication is initiated upon the granting of permissions from a patent owner and a partner that have been whitelisted.

In some embodiments, the secure channel of communication includes providing the patent owner and partner access to a virtual data room. It is contemplated that one or more virtual data rooms may be provided, and that the channel may link two virtual data rooms, one generated by each party prior to the match. For instance, the virtual data room may be automatically generated upon receipt of an input from a partner describing an invention described in a patent upon which the machine learning model is trained. Alternatively, either the partner or the patent owner may create a virtual data room to analyze, distribute, or manage patent rights. It is envisioned that this virtual data room is updated as new matches are made, new channel communications take place, the machine learning models are updated, the legal status data changes. The updates may be in real-time, daily, weekly, monthly, quarterly, annually, or at the discretion of the plan administrator.

The virtual data room may provide outputs, data, records, and visualizations from utilities within the virtual data room, including but not limited to: the output of the machine learning model which includes the patent or patents associated with the invention, notifications, registered matches, the legal file data and file history records associated with the one or more patents associated with the invention (including filing dates, expiry dates, filing deadlines, prosecution due dates, status, maintenance fee or annuity status and payment due dates), the identities of other patent owners associated with the invention, claims charts, Proud list of patents, evidence of use analysis, enablement reports, litigation metadata and access to the litigation case files or record, re-exams, oppositions or post grant proceedings data and records, court findings on claim construction and validity or invalidity, copies of agreements previously executed by the parties such as an NDA, CDA, code(s) of conduct, Terms of Service, or subscription agreement, any encumbrance on patent rights and associated documentation, e.g., license agreements that enumerate the encumbrance, product data, product crawlbot output, articles crawlbot output, market sector bot output, web-based hyperlinks, standards definitions, ownership and/or assignment data and records establishing chain of title, liens, security interests, or other burdens, and a suggested real-world price for one or more patents associated with the invention outputted from a suggested pricing algorithm. It is contemplated that these outputs, data, records, and visualizations may be provided in a web-based interface and in any combination for ease of navigation. Some or all of these outputs may be generated via artificial intelligence. Some or all of these outputs may be reports that are generated by humans. It is contemplated that not all of the listed items may be present in the virtual data room. Likewise, it is contemplated that some or all of the outputs, data, and visualizations herein may be made available outside a virtual data room or exportable from the machine learning enabled platform.

In some embodiments, the secure channel of communication includes a due diligence workflow. The due diligence workflow may include due diligence checklist items including but not limited to:

A patent list and file history and associated records, important file history dates such as filing dates, expiry dates, filing deadlines, prosecution due dates, status, maintenance fee or annuity status and payment due dates)

Litigation metadata and access to the litigation case files or record, re-exams, oppositions or post grant proceedings data and records, court findings on claim construction and validity or invalidity,

Ownership and assignment records for target patents, including copies of assignment clauses in employment agreements, copies of any liens, security interests, or other burdens on the patents

Encumbrances, including copies of any relevant agreements involving the patents, including current licenses, offers to license, covenants not to sue, settlement agreements, merger agreements, OEM arrangement agreements, agreements on importation of technology, and indemnification agreements, white list

Infringement documentation, Proud list of patents, Products, types of products or standard(s) that the patents are believed to read on, EOU (Evidence of Use) or Claim Charts (on specific products or the citing in a standard)

Suggested pricing, price comparables

A sample due diligence workflow is shown in FIG. 32 that guides the partner and patent owner through a due diligence process. Any or all of the due diligence checklist items discussed herein or otherwise known in the art may be enumerated in the workflow. The due diligence workflow may be interactive as shown and otherwise linked to one or more virtual data rooms.

In some embodiments, the secure channel of communication may include a secure messaging platform accessible to only the partner and the patent owner. The secure channel of communication may be linked to one or more virtual data rooms and a due diligence workflow. The secure channel of communication may be used for the parties to communicate about the due diligence items or the progress of the due diligence process. The secure messaging platform may, in some embodiments, be only accessible to authorized representatives of the partner and the patent owner, and not to broader groups within the entity or entities of each. The authorized representative may be a signatory to a subscription agreement or other agreement discussed herein.

In some embodiments, the secure channel of communication may include a payment workflow to support a licensing transaction. The payment workflow may include a royalty calculator and accounting system to ensure that any royalties are paid in accordance with the terms of a purchase agreement, which may include additional calculations for payment tardiness or default. For lump-sum or upfront payments, the payment workflow may include an escrow account offered by an escrow service until the transaction is deemed closed.

Upon close of the transaction, the patent rights that have been transacted may be documented within the machine learning enabled platform. For instance, the transfer of rights may be documented as a chain of title event impacting the ownership record. The price and royalty data for the transaction may be tracked and used as a comparable or otherwise used to value other patents associated with the invention.

It is contemplated that mediating the real-world discussion may require, in some embodiments, intervention by the platform administrator. For instance, mediating the real-world discussion may include providing suggestions or notifications based on the status of a due diligence workflow, for instance, encouraging a party to provide documentation to progress the due diligence process. In some embodiments, the platform administrator may mediate the real-world discussion by enforcing terms of agreements that have been entered into by the parties in the real-world or agreements that have been entered into with the platform administrator. For instance, if either party violates a term present in a code of conduct agreement, a subscription agreement, confidentiality agreement, non-disclosure agreement, or a Terms of Service, privileges to use the platform may be terminated. The agreements contemplated herein may or may not be legally binding and may be entered into by an authorized representative of the partner and/or the patent owner.

In some embodiments, the machine learning enabled system as described herein may include a processing device coupled to memory comprising instructions to further execute a suggested pricing algorithm to output a real-world price for the patent. In some embodiments the real-world price may be considered the value of the patent. The suggested pricing algorithm may take several types data points as input for the calculation, which is then provided to the parties to assess the value of the patent and associated invention. Data points and/or metadata contemplated in the scope of this invention include but are not limited to:
Patent data and/or metadata, e.g., patent data taken from a PAIR or OPS database or patent database
Size of patent family and jurisdiction(s) in which rights have been preserved
Status of patents, for example, issued patents (quantity and quality), pending applications (quantity and quality), Wherein the suggested pricing algorithm takes as input one or more metadata of the patent
Identity of the patent owner, patent owner reputation in the real world
Patent owner stock price, e.g., last private valuation or as traded on a public exchange
Industry benchmarks for patent pricing, patent value by industry or patent value by invention.

In some embodiments, the machine learning enabled system as described herein may further include an analytics database to store the outputs, data, records, and visualizations of one or more virtual data rooms (or deal rooms), secure channels, agreements (legally binding or not, between the parties or between a party and the platform administrator as discussed herein such as code(s) of conduct, Terms of Service, NDA, CDA), due diligence workflows and associated records and documentation discussed herein, messages, notifications indicating willingness to transact, whitelists, matches, identities, records (e.g., ownership, litigation, re-exam, opposition) and the like.

While the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention. For instance, a machine learning enabled system has been disclosed herein, but one skilled in the art will recognize that various methods can implemented. Likewise, the system as disclosed makes use of computer-readable media and computer-readable storage media and as such aspect of the claims may utilize these media for the purposes of executing the methods and systems described herein.

1. A machine learning enabled platform system, comprising:
A machine learning model stored in memory, the machine learning model trained on a plurality of patents owned by patent owners, the plurality of patents containing inventions;
A processing device operatively coupled to memory comprising instructions, wherein the processing device is configured to:
Receive an input from a partner, the input including an identity of the partner and associated with an invention described in a patent upon which the machine learning model is trained;
Query the machine learning model to output an identity of at least one patent owner associated with the invention and the patent associated with the patent owner;
Receive a notification from the patent owner associated with the invention indicating a willingness to transact the patent;
Register a match between the partner and the patent owner based on an identity of the partner and an identity of the patent owner;
Initiate a real-world discussion between the patent owner and the partner regarding the invention described in the patent; and
Mediate the real-world discussion by providing a secure channel of communication between the patent owner and the partner within the platform.

2. The system of claim 1, wherein the plurality of patents upon which the machine learning model is trained comprises the global patent corpus.

3-4. (canceled)

5. The system of claim 1, wherein the received input associated with the invention is a key phrase describing the invention, wherein the key phrase is a noun phrase, a verb phrase, a prepositional phrase, or any combination thereof.

6. The system of claim 1, wherein the received input associated with the invention is a second patent describing the invention.

7. The system of claim 1, wherein the received input associated with the invention is metadata associated with the patent, such as the application number, serial number, publication number, patent number, or any combination thereof.

8. The system of claim 1, wherein the received input associated with the invention is free form text.

9. The system of claim 1, wherein the received input associated with the invention is a description of a product.

10. The system of claim 1, wherein the received input is stored in a database and communicated to the partner via a front-end virtual data room.

11. The system of claim 1, wherein the received input associated with the invention hides the identity of the partner from the patent owner.

12. The system of claim 1, wherein the received input associated with the invention is stored in an analytics database.

13-15. (canceled)

16. A machine learning enabled platform system, comprising:
A machine learning model stored in memory, the machine learning model trained on a plurality of patents owned by patent owners, the plurality of patents containing inventions;
A processing device operatively coupled to memory comprising instructions, wherein the processing device is configured to:
Receive an input from a partner, the input including an identity of the partner and associated with an invention described in a patent upon which the machine learning model is trained;
Query the machine learning model to output an identity of at least one patent owner associated with the invention and the patent associated with the patent owner;
Receive a notification from the patent owner associated with the invention indicating a willingness to transact the patent;
Register a match between the partner and the patent owner based on an identity of the partner and an identity of the patent owner:
Initiate a real-world discussion between the patent owner and the partner regarding the invention described in the patent;
mediate the real-world discussion by providing a secure channel of communication between the patent owner and the partner within the platform; and
wherein the received notification is stored in a database until a second notification is received from the partner indicating a willingness to transact the patent.

17. The system of claim 16, wherein the second received notification indicates the partner's willingness to buy the patent.

18. The system of claim 16, wherein the second received notification indicates the partner's willingness to license the patent.

19. (canceled)

20. A machine learning enabled method, comprising the steps of:
Storing a machine learning model in memory, the machine learning model trained on a plurality of patents owned by patent owners, the plurality of patents containing inventions;
Configuring a processing device operatively to memory comprising instructions, wherein the processing device is configured to:
Receive an input from a partner, the input including an identity of the partner and associated with an invention described in a patent upon which the machine learning model is trained;
Query the machine learning model to output an identity of at least one patent owner associated with the invention and the patent associated with the patent owner;
Receive a notification from the patent owner associated with the invention indicating a willingness to transact the patent;
Register a match between the partner and the patent owner based on an identity of the partner and an identity of the patent owner:
Initiate a real-world discussion between the patent owner and the partner regarding the invention described in the patent;
mediate the real-world discussion by providing a secure channel of communication between the patent owner and the partner within the platform; and
wherein the received notification is stored in a database until a second notification is received from the partner indicating a willingness to transact the patent.

21. (canceled)

22. The system of claim 1, wherein the match is registered if the patent owner has whitelisted the identity of the partner from a list of partner identities generated from the output of the machine learning model.

23-35. (canceled)

36. The method of claim 20, wherein the real-world discussion is initiated after an authorized representative of the partner and an authorized representative of the patent owner have entered into a legally binding confidentiality agreement.

37. (canceled)

38. The system of claim 1, wherein the secure channel of communication includes providing the patent owner and partner access to a virtual data room.

39-58. (canceled)

59. The system of claim 1, wherein the processing device is further configured to automatically generate a virtual data room upon receipt of an input from a partner.

60. The system of claim 1, wherein the processing device is further configured to execute a suggested pricing algorithm to output a real-world price for the patent.

61. The system of claim 60, wherein the suggested pricing algorithm takes as input one or more metadata of the patent.

62-73. (canceled)
